(19) United States
(12) Patent Application Publication
(10) Pub. No.: US 2012/0033944 A1
(43) Pub. Date: Feb. 9, 2012

(54) INFORMATION PROCESSING DEVICE, INFORMATION PROCESSING METHOD, AND PROGRAM

(75) Inventors: Shinobu Hattori, Tokyo (JP); Kenjiro Ueda, Kanagawa (JP); Yoshiyuki Kobayashi, Tokyo (JP); Motoki Kato, Kanagawa (JP); Kazuo Yamamoto, Chiba (JP)

(73) Assignee: SONY CORPORATION, Tokyo (JP)

(21) Appl. No.: 13/192,572

(22) Filed: Jul. 28, 2011

(30) Foreign Application Priority Data
Aug. 9, 2010 (JP) P2010-178425

(51) Int. Cl. H04N 9/80

(52) U.S. Cl. 386/248; 386/E05.001

(57) ABSTRACT

Disclosed is an information processing device including: a communication section that performs data communication; and a data processing section that performs a process of transmitting reproduction data and reproduction control information to a client via the communication section and reproducing the reproduction data based on the reproduction control information in the client, wherein the data processing section performs a process of converting the reproduction control information into a data format analyzable by the client and transmitting the converted reproduction control information to the client.

### CROSS-REFERENCE TO RELATED APPLICATION

The present application claims priority from Japanese Patent Application No. JP 2010-178425 filed in the Japanese Patent Office on Aug. 9, 2010, the entire content of which is incorporated herein by reference.

### BACKGROUND

The present disclosure relates to an information processing device, an information processing method, and a program. More particularly, the disclosure relates to an information processing device that is used to transmit or reproduce content via a network such as a home network, an information processing method thereof, and a program thereof.

As a medium (media) storing information on various content items such as movies or music, in recent years, a DVD (Digital Versatile Disc), a BD (Blu-ray Disc (registered trademark)), and the like have been widely used. In a considerable number of content items such as music data and image data stored on the information storage medium, the writer, the seller, or the like has the copyright or the distribution rights thereof. Accordingly, even a user purchasing the disk may use the content stored on the disk within a predetermined limitation. For example, the user is not permitted to copy the content stored on the disk to a media such as another disk without any limitation.

As a configuration of managing the copy of the content stored on the media, a management configuration (managed copy (MC)) may be exemplified in which the copy is permitted on the basis of the receipt of copy permission information from a management server. The detailed sequence of the managed copy (MC) is as below.

A media such as a content storage disk is loaded on a user device such as a PC or a recording and reproducing device, and the user device is connected to the management server via a network.

Subsequently, the user device transmits predetermined information such as a disk identifier (ID) to the server.

The server checks the validity or the like of the received information, and then transmits the copy permission information to the user device.

The user device starts the copy process on the basis of the receipt of the copy permission information from the server.

In accordance with the sequence, the copy process is permitted so that the content stored on the disk is copied to another media.

The copy management configuration is called the managed copy (MC), and is specifically described in, for example, Japanese Unexamined Patent Application Publication No. 2008-98765.

On the other hand, an AACS (Advanced Access Content System) standard may be exemplified as a standard relating to the content copyright protection technology. A considerable number of content items stored on the disk such as a BD in accordance with the AACS standard are stored as encrypted content. As a representative encryption configuration of the AACS standard, a configuration may be exemplified in which the content items are divided into separate units and a different encryption key is applied to each unit. By adopting such an encryption configuration, the content items may be used and controlled by the unit, and the content items may be strictly and variously used and controlled.

The unit as the content dividing unit is called a CPS unit, and the encryption key applied to the encryption process or the decoding process of each CPS unit is called a CPS unit key, a unit key, or a title key.

As described above, when the user device copies a media storage content such as a BD (Blu-ray Disc (registered trademark)) storing a movie or the like corresponding to a copyright management object to another media, for example, a hard disk, a flash memory, or another disk, the copy process is performed in accordance with the above-described managed copy (MC) by receiving the copy permission information from the management server.

The copy content may be used, for example, such that a recording and reproducing device having a hard disk storing copy content is set as a home server, the copy content is transmitted to display devices such as TVs in various rooms in the home via the home network, and the content is reproduced.

As a standard for defining the specification when using content via a home network in the case where various devices are connected to each other via the home network and digital content items such as a video, an audio, and a picture are shared and enjoyed, for example, a DLNA (Digital Living Network Alliance) may be exemplified.

The DLNA (Digital Living Network Alliance) sets the technical specification or the loading guideline necessary for sharing the content by the digital device and enables connection between devices manufactured by different vendors, and is used as an industry standard of a home IP network.

As a protocol for connecting devices such as a PC, a peripheral device, an AV device, a telephone, and a home appliance via a network to provide their functions for each other, for example, an UPnP (Universal Plug and Play) is used.

In the home network based on the UPnP or the DLNA, for example, a device list which is a list of devices connected to each other via a network may be suggested on one device manipulated by a user. The user may select a device to be controlled from the list, and perform a control for the selected device, for example, an image transmission request via a network.

However, for example, the content stored on the BD-ROM may have a specific reproduction function. For example, the specific reproduction function may be reproduction by the unit of a chapter (a predetermined reproduction section) set as content such as a movie. Specifically, there is content which is reproduced after skipping to a specific chapter using chapter information including a chapter start point and the like or content having a voice/subtitle selection function of optionally reproducing a plurality of voices or subtitles. The content performs, for example, the skip reproduction, the voice/subtitle selection output, and the reproduction in accordance with the selection information or the command input from the user.

The control information for realizing such reproduction function is stored on a reproduction control information file (for example, a playlist file, a clip information file, and the like) of original content. Accordingly, in the device capable of analyzing and reproducing the reproduction control information file (for example, the playlist file, the clip information file, and the like), the specific reproduction function may be used without any problem. However, for example, in the device (DLNA device) transmitting the content in accordance with the DLNA standard, the above-described reproduction control information (for example, the playlist file, the clip information file, or the like) may not be correctly analyzed. In this case, such a device may not use the chapter skip function or the audio/subtitle selection reproduction function.

That is, the reproducing device in accordance with the specification of the DLNA, that is, the DLNA device may be configured as a device that analyzes and reproduces the command or the reproduction control information in accordance with the DLNA standard. However, since the control data (for example, storage data such as the playlist file or the clip information file) for performing the reproduction process or the voice/subtitle selection reproduction process using the chapter information defined in the above-described copy content does not correspond to the DLNA standard, a part of the original reproduction function provided in the content may not be used in the reproducing device of the content transmission destination.

Likewise, when the content is reproduced through the transmission via the network, in some cases, the reproduction may not be performed in accordance with the original reproduction control information.

### SUMMARY

It is desirable to provide an information processing device capable of allowing a content reproducing device at a content transmission destination to use all reproduction functions provided in original content when the content is transmitted via a network such as a home network, an information processing method thereof, and a program thereof.

It is desirable to provide an information processing device capable of allowing a content reproducing device at a content transmission destination to use all reproduction functions provided in original content when copy content is transmitted via a network by setting a device having a second media (a hard disk and the like) storing copied data of content stored on a first media such as a BD as a server, an information processing method, and a program.

According to a first embodiment of the disclosure, there is provided an information processing device including: a communication section that performs data communication; and a data processing section that performs a process of transmitting reproduction data and reproduction control information to a client via the communication section and reproducing the reproduction data based on the reproduction control information in the client, wherein the data processing section performs a process of converting the reproduction control information into a data format analyzable by the client and transmitting the converted reproduction control information to the client.

Furthermore, in the embodiment of the information processing device of the disclosure, the reproduction control information may be chapter information, and the data processing section may perform a process of converting chapter reproduction start time information included in the chapter information into real-time information expressed by the units of hours, minutes, and seconds and transmitting the real-time information to the client.

Furthermore, in the embodiment of the information processing device of the disclosure, the data processing section may perform a process of converting timestamp information representing chapter start time information in the chapter information stored on a playlist file as a reproduction control information file set to correspond to the reproduction data into real-time information expressed by the units of hours, minutes, and seconds and transmitting the real-time information to the client.

Further, in the embodiment of the information processing device of the disclosure, the reproduction data and the reproduction control information to be transmitted to the client may be copied data obtained by causing the data processing section to copy data stored on a first media to a second media under the management of a management server.

Furthermore, according to a second embodiment of the disclosure, there is provided an information processing device including: a communication section that performs data communication; and a data processing section that performs a process of transmitting reproduction data and reproduction control information to a client via the communication section and reproducing the reproduction data based on the reproduction control information in the client, wherein the data processing section performs a process of receiving stream selection information selected by the client on the basis of the reproduction control information transmitted to the client, selecting a transmission stream in accordance with the received stream selection information, and transmitting the selection stream to the client.

Furthermore, in the embodiment of the information processing device of the disclosure, the reproduction control information may be voice/subtitle selection information, and the data processing section may perform a process of transmitting voice/subtitle option information to the client, receiving the voice/subtitle selection information selected by the client, selecting at least any one of a voice stream and a subtitles stream to be transmitted in accordance with the received selection information, and transmitting the selection stream to the client.

Furthermore, in the embodiment of the information processing device of the disclosure, the data processing section may perform a process of transmitting storage information of a stream number table (STN_table) storing information relating to voice or subtitles stored on a playlist file as a reproduction control information file set to correspond to reproduction data to the client as the option information and receiving the voice/subtitle selection information selected by the client on the basis of the stream number table (STN_table).

Furthermore, in the embodiment of the information processing device of the disclosure, the reproduction data and the reproduction control information to be transmitted to the client may be copied data obtained by causing the data processing section to copy data stored on a first media to a second media under the management of a management server.

Furthermore, according to a third embodiment of the disclosure, there is provided an information processing device including: a communication section that performs data communication; and a data processing section that receives reproduction control information from a server via the communication section, transmits stream selection information selected on the basis of the received reproduction control information to the server, and reproduces data based on a stream transmitted from the server in accordance with the stream selection information.

Furthermore, in the embodiment of the information processing device of the disclosure, the reproduction control information may be voice/subtitle selection information, and the data processing section receives the voice/subtitle option information from the server, transmits the selection information of at least either the voice or the subtitles to the server, and reproduces data based on at least either the voice or the subtitles transmitted from the server in accordance with the selection information.

Furthermore, according to a fourth embodiment of the disclosure, there is provided an information processing method performed by an information processing device, including: causing a data processing section to perform data processing by transmitting reproduction data and reproduction control information to a client via a communication section and reproducing data based on the reproduction control information in the client, wherein in the data processing, the reproduction control information is converted into a data format analyzable by the client and the converted reproduction control information is transmitted to the client.

Furthermore, according to a fifth embodiment of the disclosure, there is provided an information processing method performed by an information processing device, including: causing a data processing section to perform data processing by transmitting reproduction data and reproduction control information to a client via a communication section and reproducing data based on the reproduction control information in the client, wherein in the data processing, stream selection information selected by the client on the basis of the reproduction control information transmitted to the client is selected, a transmission stream is received in accordance with the received stream selection information, and the selection stream is transmitted to the client.

Furthermore, according to a sixth embodiment of the disclosure, there is provided an information processing method performed by an information processing device, including: causing a data processing section to receive reproduction control information from a server via a communication section, transmitting stream selection information selected on the basis of the received reproduction control information to the server, and reproducing data based on the stream transmitted from the server in accordance with the stream selection information.

Furthermore, according to a seventh embodiment of the disclosure, there is provided a program causing an information processing device to perform an information process, the program causing a data processing section to perform data processing by transmitting reproduction data and reproduction control information to a client via a communication section and reproducing data based on the reproduction control information in the client, wherein in the data processing, the reproduction control information is converted into a data format analyzable by the client, and the converted reproduction control information is transmitted to the client.

Furthermore, according to an eighth embodiment of the disclosure, there is provided a program causing an information processing device to perform an information process, the program causing a data processing section to perform data processing by transmitting reproduction data and reproduction control information to a client via a communication section and reproducing data based on the reproduction control information in the client, wherein in the data processing, stream selection information selected by the client on the basis of the reproduction control information transmitted to the client is received, a transmission stream is selected in accordance with the received stream selection information, and the selection stream is transmitted to the client.

Furthermore, according to a ninth embodiment of the disclosure, there is provided a program causing an information processing device to perform an information process, the program causing a data processing section to receive reproduction control information from a server via a communication section, transmit stream selection information selected on the basis of the received reproduction control information to the server, and reproduce data based on a stream transmitted from the server in accordance with the stream selection information.

Furthermore, the program of the disclosure is, for example, a program that may be provided for an information processing device or a computer system capable of performing various programs and codes via a communication medium and a storage medium provided in a format to be readable by the computer. Since the program is provided in the format to be readable by the computer, a process based on the program is performed on the information processing device, the computer, or the system.

Other objects, characteristics, or advantages of the disclosure will become more apparent by the more detailed description based on the embodiments of the disclosure or the accompanying drawings. Furthermore, the system of the specification is a logical assembly structure of a plurality of devices, and it is not limited such that the device of each structure is present in the same casing.

According to the configuration of the embodiment of the disclosure, there is provided the device and the method of allowing the client to perform the reproduction process without any problem using the reproduction control information for the transmission content. In order to provide the reproduction data and the reproduction control information from the server to the client and allow the client to reproduce the data based on the reproduction control information, the server converts the reproduction control information into the data format analyzable by the client and transmits the converted reproduction control information to the client. For example, the timestamp representing the chapter reproduction time is converted into time information expressed by the units of hours, minutes, and seconds. Further, the server transmits the voice/subtitle option information to the client, receives the voice/subtitle selection information selected by the client, selects a voice/subtitles stream to be transmitted in accordance with the received selection information, and transmits the stream to the client.

According to the process, for example, even when description of the playlist file as the reproduction control information file is not analyzable, it is possible for the client to perform the reproduction control such as a chapter skip function or a voice/subtitle selection function which is the same as the process in accordance with the description of the playlist file.

### BRIEF DESCRIPTION OF THE DRAWINGS

FIG. 1 is a diagram illustrating an outline of a managed copy (MC) system;

FIG. 2 is a diagram illustrating a unit configuration and a unit key management table;

FIG. 3 is a diagram illustrating a configuration example of a media directory;

FIG. 4 is a diagram illustrating a sequence of a copy process (MC) managed by a management server;

FIG. 5 is a diagram illustrating configuration data of a managed copy manifest file (MCMF) that is storage information of a first media;

FIG. 6 is a diagram illustrating an example of data included in a copy performing request;

FIG. 7 is a diagram illustrating basic information included in server response information (Offer Response);

FIG. 8 is a diagram illustrating an example of a copy process from a first media serving as a copy source to a second media (a hard disk (HDD)) serving as a copy destination;

FIG. 9 is a diagram illustrating a configuration example of a home network;

FIG. 10 is a diagram illustrating a configuration example and an application example of a playlist file;

FIG. 11 is a diagram illustrating a configuration example and an application example of the playlist file;

FIGS. 12A and 12B are diagrams illustrating a syntax (a data structure) of a playlist file and a playlist mark that is a part of the playlist file;

FIGS. 13A and 13B are diagrams illustrating a setting example of a mark timestamp that is chapter information stored on a playlist file and a corresponding example of an AV stream;

FIGS. 14A and 14B are diagrams illustrating a process in which a timestamp indicating a chapter start position is converted into time information (hours, minutes, and seconds) analyzable by a client device and is provided for the client device;

FIGS. 15A and 15B are diagrams illustrating a syntax of a playlist file and a stream number table (STN_table) included in the playlist file;

FIGS. 16A and 16B are diagrams illustrating reproduction control information (STN) transmitted from a server to a client and selection information (UI) output from the client;

FIG. 17 is a diagram illustrating a transmission example from a client of selection information based on a user's selection to a server;

FIG. 18 is a flowchart illustrating a sequence of a process performed by an information processing device serving as a server;

FIG. 19 is a flowchart illustrating a sequence of a process performed by an information processing device serving as a client;

FIG. 20 is a diagram illustrating a configuration example of the information processing device serving as the server; and

FIG. 21 is a diagram illustrating a configuration example of the information processing device serving as the client.

### DETAILED DESCRIPTION OF EMBODIMENTS

Hereinafter, an information processing device, an information processing method, and a program of the disclosure will be specifically described by referring to the accompanying drawings. Furthermore, the description thereof will be performed in accordance with the following items.

1. Outline of content copy control process based on management of server

2. Storage configuration example of content

3. Sequence of content copy process based on management of server

4. Network transmission process of content

5. Sequence of process performed by information processing device

6. Configuration example of information processing device

### [1. Outline of Content Copy Control Process Based on Management of Server]

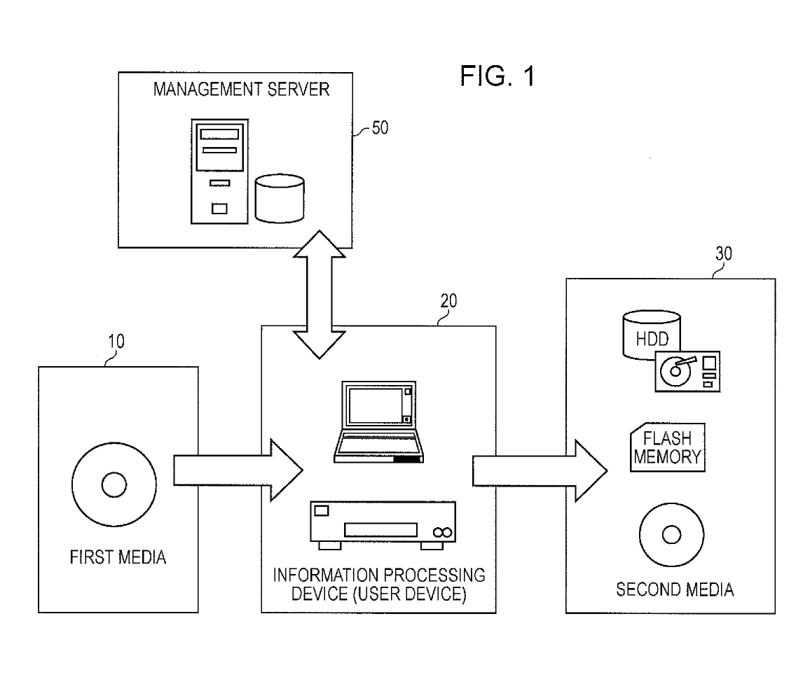

First, the outline of the content copy control process based on the management of the server will be described by referring to FIG. 1.

A considerable number of content items such as movies stored on, for example, BD (Blu-ray Disc (registered trademark)) or the like is permitted to be used under a predetermined copyright management. Accordingly, even a user purchasing a disk may use content stored on the disk within a predetermined limitation. For example, the user is not permitted to copy the content stored on the disk to a media such as another disk without any limitation.

As a configuration of managing the copy of the content stored on the media, a configuration may be exemplified in which a copy permission process is performed on the basis of the receipt of copy permission information from a management server. FIG. 1 is a diagram illustrating an outline of a managed copy (MC) system which is an example thereof.

An information processing device 20 is a PC, a recorder (a recording and reproducing device), or the like of the user, and may load and reproduce a first media 10 having a content such as a movie stored thereon which is a copyright management object used within a predetermined limitation.

The information processing device 20 may perform a process in which the content stored on the first media 10 is copied to a second media 30 which is another media. The second media 30 is a media on which information may be stored by the information processing device 20, and is for example, a media such as a hard disk (HDD), a flash memory, or disc (BD, DVD, or the like) capable of storing data thereon.

However, when the user freely performs the copy process, the content is repeatedly copied, and the copy content is illegally used or distributed. In order to prevent such a situation, when the information processing device 20 serving as the user device performs the copy of the content, the information processing device receives copy permission information from the management server 50 while being connected to the management server 50. In the receipt of the copy permission information, for example, it is necessary to perform a procedure such as a validity checking process of the first media belonging to the user or a predetermined payment process.

When the information processing device 20 serving as the user device performs the predetermined procedure, the information processing device 20 receives the copy permission information from the management server 50, and may copy the content on the basis of the receipt of the copy permission information. This is the outline of the managed copy (MC).

### [2. Storage Configuration Example of Content]

Next, a configuration example of data stored on a media (the first media 10 of FIG. 1) having an object of the managed copy (MC), for example, use control content of which the copyright is managed will be described.

A considerable number of content items such as movies stored on a general disk, for example, a BD (Blu-ray Disc (registered trademark))-ROM is encrypted in order to prevent illegal use such as illegal copying.

The encrypted content according to the AACS (Advanced Access Content System) standard as a standard relating to a content copyright protection technology is divided into units as described above, and is stored as encrypted data in which a different encryption key is applied to each unit. By adopting the encryption configuration by the unit, the content items may be used and controlled by the unit, and the content items may be strictly and variously used and controlled.

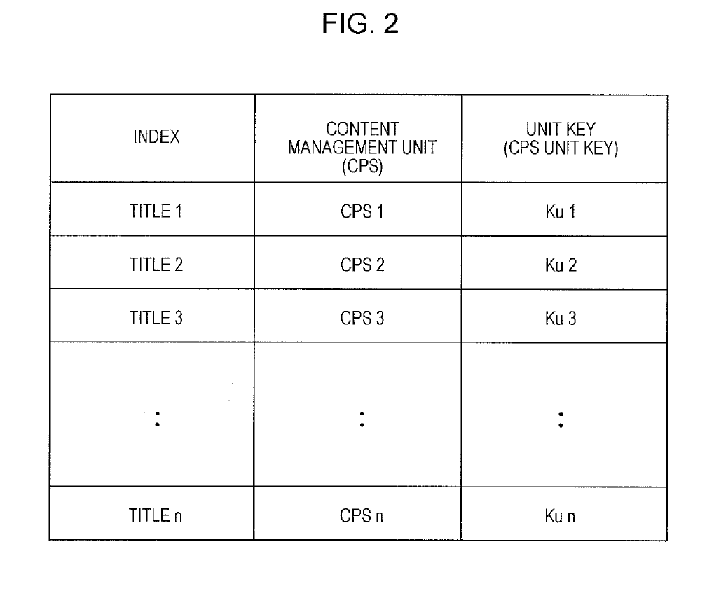

The unit as the content dividing unit is called a content management unit or a CPS unit, and the encryption key corresponding to each CPS unit is called a CPS unit key, a unit key, or a title key. An example of a relationship between the content dividing unit stored on the disk and the encryption key (the unit key) is shown in FIG. 2.

FIG. 2 is an example of a unit key management table illustrating a relationship between a unit (a CPS unit) constituting content stored on one media, for example, one disk and a CPS unit key serving as an encryption key. The unit key management table is stored on the media (BD or the like) together with the encrypted content.

As shown in FIG. 2, the CPS unit as a content configuration data is divided into CPS units 1 to n. The CPS unit key serving as the original encryption key is correlated to each of the CPS units 1 to n.

For example, when the CPS unit 1 (CPS1) is reproduced, it is necessary to perform decoding using the CPS unit key 1 (Ku1). When the CPS unit 2 (CPS2) is reproduced, it is necessary to perform decoding using the CPS unit key 2 (Ku2). As an index corresponding to each CPS unit and each CPS unit key, for example, a “title” is used. The “title” is an index that is set to correspond to each CPS unit, and when the title is specified, the CPS unit and the CPS unit key may be specified.

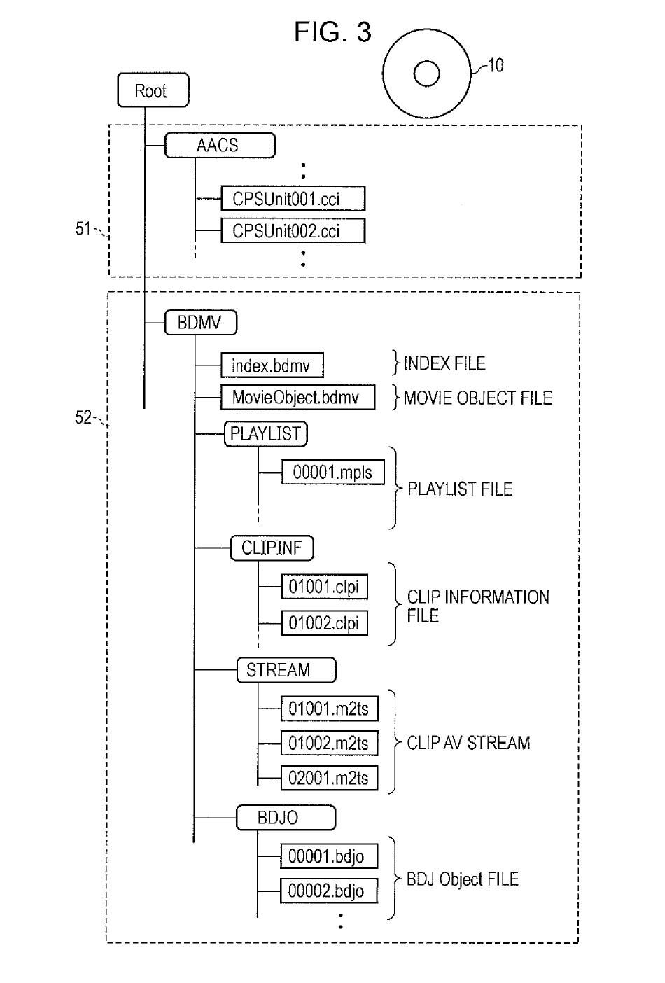

FIG. 3 illustrates a directory when the first media is a ROM-type Blu-ray Disc (registered trademark), and illustrates a configuration of a directory corresponding to data stored on the BD (Blu-ray Disc (registered trademark)).

As shown in FIG. 3, the directory is divided into a management information setting part 51 (an AACS directory) and a data part 52 (a BDMV directory).

The management information setting part 51 (the AACS directory) stores a CPS unit key file, a use control information file, and the like.

On the other hand, the data part 52 stores, for example, an index file, a movie object file, a playlist file, a clip information file, a clip AV stream file, and a BDJO file below the BDMV directory.

The index file stores title information as index information applied to a reproduction process. The title is the same as the title registered on the unit key management table described above by referring to FIG. 2, and is data correlated to the CPS unit.

The movie object file is a file that stores a reproduction program.

The playlist file is a file that sets the reproduction sequence of the content. The playlist file is selected in accordance with the title selected by the user, and a specific clip information file is designated as a reproduction object in accordance with the play item or the path information included in the selected playlist file.

The clip information file is a file that is designated by the playlist file, and includes reproduction position information and the like of the clip AV stream file.

The clip AV stream file is a file that stores AV stream data corresponding to the reproduction object.

Furthermore, the clip information file and the clip AV stream file may be generally called a clip or a clip file.

The BDJO file is a file that stores performing control information of a file storing a JAVA (registered trademark) program, a command, and the like.

As described above, image data or audio data corresponding to a reproduction object is stored on the clip AV stream file, and the index file, the movie object file, the playlist file, and the clip information file store a variety of reproduction control information such as an index, a program, sequence information, and data location information necessary for reproducing the image data or the audio data stored on the clip AV stream file, and these are used as storage files of the reproduction control information.

The sequence of reproducing the content stored on the information storage medium by the information processing device is as below.

First, a specific title is designated from the index file by a reproduction application.

A reproduction program relating to the designated title is selected.

A playlist defining the reproduction sequence of the content is selected in accordance with the program information of the selected reproduction program.

An AV stream or a command is read out as actual content data in accordance with clip information defined by the selected playlist, so that the AV stream is reproduced or a command is performed.

In the content reproduction process, the unit and the unit key described above by referring to FIG. 2 may be distinguished in accordance with the selected title, and the decoding process for each unit is performed by acquiring the unit key corresponding to the unit (the encrypted content) of the reproduction object. When the copy process described by referring to FIG. 1 is performed, the copy process is performed by specifying copy object data with reference to information received from the management server 50.

### [3. Sequence of Content Copy Process Based on Management of Server]

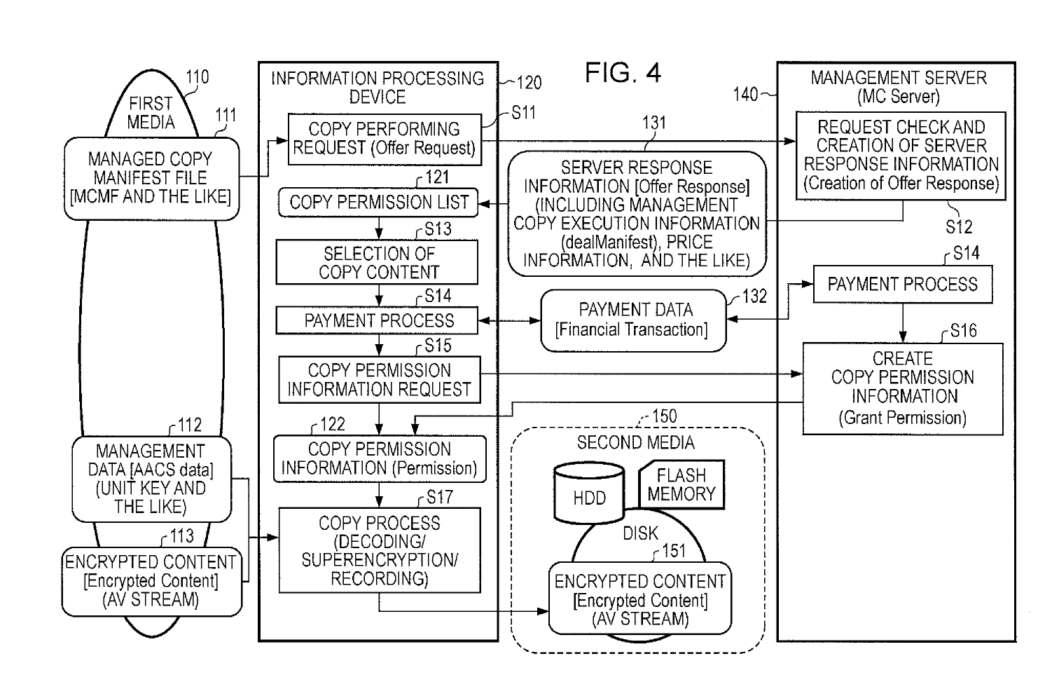

Next, a sequence of a content copy process based on the management of the server will be described by referring to FIG. 4. FIG. 4 is a diagram illustrating a sequence of the managed copy (MC) that is an example of the content copy process based on the management of the server.

From the left side of FIG. 4, there are shown a first media 110 such as a ROM disk having content such as a movie stored thereon, an information processing device 120 serving as a user device reading out data such as content from the first media 110 and performing a copy process, a second media 150 serving as a media of a content copy destination and including a hard disk (HDD), a flash memory, or a R/RE disk, and a management server (MC server) 140 performing a process of providing content copy permission information or the like.

The information processing device 120 is configured as, for example, a PC, a recording and reproducing device, or the like, reads out data from the first media 110, and performs a process, that is, a content copy process in which data is stored on the second media 150 serving as a copy destination media configured as a hard disk (HDD), a flash memory, an R/RE disk, or the like.

The first media 110 is, for example, a ROM-type Blu-ray Disc (registered trademark), a DVD, or the like. The second media 150 is a media capable of writing data thereon, and is specifically configured as, for example, a hard disk (HDD), a flash memory, an R-type or RE-type Blu-ray Disc (registered trademark), a DVD, or the like.

Encrypted content 113 as use control content is stored on the first media 110 configured as, for example, a ROM disk or the like as shown in the drawing. The encrypted content 113 is content including text data, voice data, image data, a game program, music data, or an AV (Audio Visual) stream of video content such as an HD (High Definition) movie content as a high definition video data.

As described above by referring to FIG. 2, the encrypted content 113 has a use management configuration by the unit of the content management unit (CPS unit), and is encrypted content which is encrypted by applying a different unit key (CPS unit key) to each CPS unit. That is, in order to realize the different use control for each separate data items by the unit, each unit is encrypted by a different key (called a CPS unit key, a unit key, or a title key).

Furthermore, the first media 110 stores key information applied to decode the encrypted content 113, management data (AACS Data) 112 including use control information and the like, and a managed copy manifest file (MCMF) 111 used to perform the copy process of the content stored on the first media 110. The managed copy manifest file (MCMF) will be described later.

The management data 112 indicated as the storage information of the first media 110 shown in FIG. 4 is management data defined by, for example, an AACS (Advanced Access Content System) as a management system relating to the content copyright protection technology, and is data including a CPS unit key file storing a key (unit key) applied to decode the encrypted content 113, a content certificate (CC) representing use permission information and validity of the content, an encryption key block (MKB (Media Key Block)) storing a media key for acquiring the CPS unit key, and the like.

The MKB (Media Key Block) will be simply described. The MKB is an encryption key block which is created on the basis of a key transmission type known as one type of a broadcast encryption type. The MKB is a key information block that permits acquisition of the media key [Km] necessary for decoding the content only by the (decoding) process based on the device key [Kd] stored on the information processing device of the user having a valid license. In this KMB, an information transmission type in accordance with a so-called hierarchical tree structure is applied, and only when the user device (the information processing device) has a valid license, the media key [Km] may be acquired. Then, in an invalid (revoked) user device, the media key [Km] may not be obtained. The device key [Kd] is stored on the memory of the information processing device 120 shown in FIG. 2.

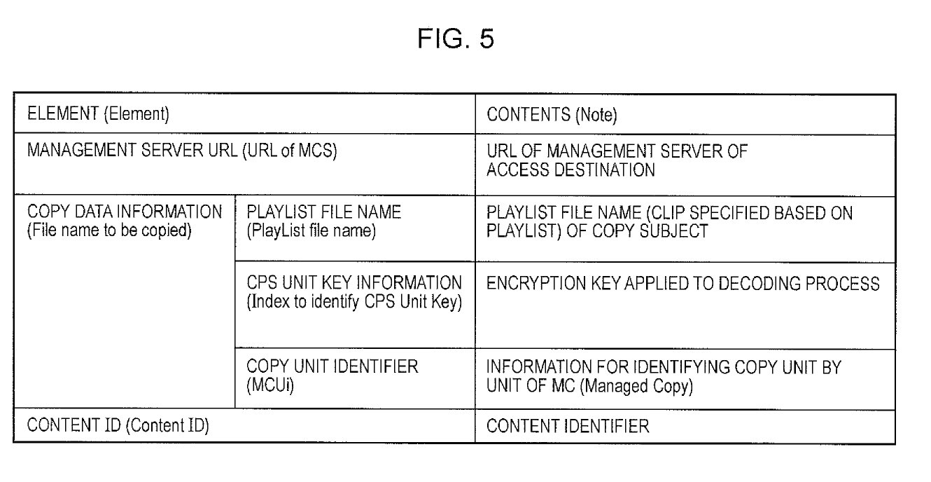

The managed copy manifest file (MCMF) 111 shown as the storage information of the first media 110 shown in FIG. 4 is a file that is applied to perform the copy process of the content 113 stored on the first media 110 and, for example, XML data including data shown in FIG. 5.

(1) Management server URL: access information of management server providing copy permission information and access information with respect to management server 140 shown in FIG. 4

(2) Copy data information (dealManifest)
(2-1) Playlist file name: file name of playlist as copy object
(2-2) CPS unit key information: identification information of CPS unit key applied to decoding process on copy object content
(2-3) Copy unit identifier: unit identification information of copy unit (MC unit) representing copy unit of managed copy (MC)

(3) Content ID: identifier of content as copy object and, for example, ISAN (International Standard Audiovisual Number) number as content code information

Referring to FIG. 4, a sequence of a process will be described in which the encrypted content 113 stored on, for example, the first media 111 configured as a ROM disk is copied to the second media 150 configured as another media such as a hard disk or an R/RE disk.

First, in step S11, the information processing device 120 transmits a copy performing request (Offer Request) to the management server 140 by applying the server information (URI and the like) stored on the managed copy manifest file (MCMF) 111 of the first media 110.

At this time, the content ID or the like corresponding to the content as the copy process object is transmitted to the management server 140.

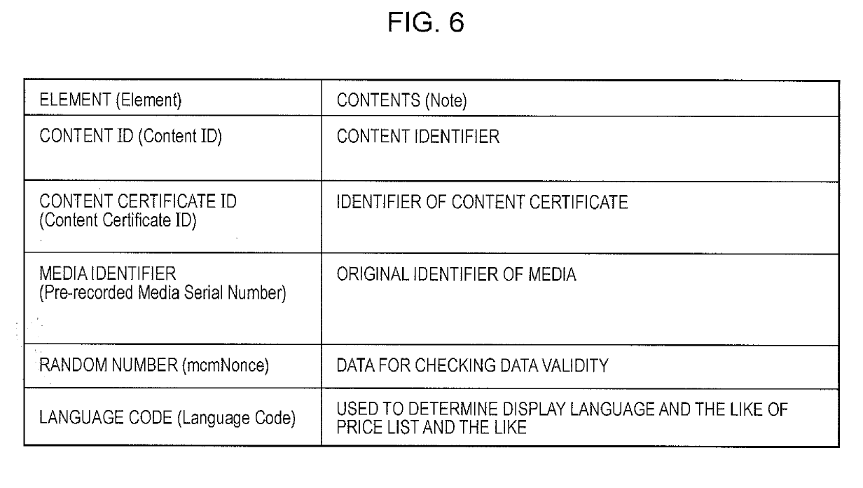

An example of data included in the copy performing request is shown in FIG. 6. As shown in FIG. 6, the copy performing request includes, for example, the following data.

(a) Content ID: identifier of content stored on first media

(b) Content certificate ID: certificate for verifying validity of content

(c) Media identifier: identifier of first media as copy source

(d) Random number: data for verifying data validity

(e) Language code: code information of language used in information processing device

The information (a) to (c) among the information above is read out from the first media 110. The random number (d) is created in the information processing device 120. The language code (e) is transmitted by acquiring the language code stored in advance in the memory of the information processing device 120.

Furthermore, the language code is used to determine a language or the like of the specific offer information included in the response provided from the management server 140.

Returning to FIG. 4, the sequence of the copy process of the content in accordance with the server management will be described. In step S12, the management server 140 performs a verification process of the validity or the like of the validity of the received information such as the content ID received from the information processing device 120, and when it is checked that there is no problem, the management server creates the server response information (Offer Response) 131 and transmits the server response information to the information processing device 120.

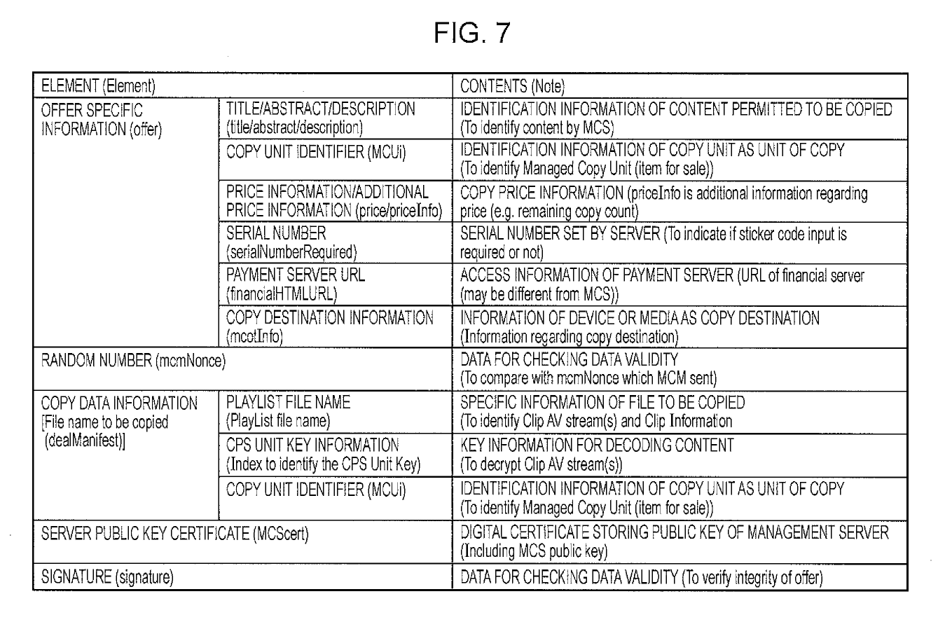

The basic information included in the server response information (Offer Response) 131 provided for the information processing device 120 from the management server 140 will be described by referring to FIG. 7.

The basic information includes the following information.

(1) Specific offer information
(1a) Title/abstract/description: information on title, abstract, and description corresponding to copy permission content
(1b) the copy unit identifier (MCU): identifier for identifying copy unit as unit of copy
(1c) Price information (price): price information of copy
(1d) Additional price information (priceInfo): additional information of price
(1e) Payment server URL (financialHTMLURL): access information of server performing payment process of copy price
(1f) Copy destination information (mcotInfo): information representing type of media permitted as copy destination device and, for example, media such as HDD or flash memory

(2) Random number (mcmNonce): random number for checking validity of data

(3) Copy data information (File name to be copied) (=dealManifest)
(3a) Playlist file name (PlayList file name): file name of playlist as copy object and clip information file or clip AV stream file specified by specific playlist
(3b) CPS unit key information (Index to identify the CPS Unit Key): identification information of key (CPS unit key) for decoding copy content
(3c) Copy unit identifier (MCUi): identification information of copy unit (MCU) representing unit of copy

(4) Server public key certificate (MCScert): certificate storing public key of server used for encryption communication and signature check

(5) Signature: signature data for checking falsification with respect to total data

The information is basic information included in the server response information (Offer Response) 131 provided for the information processing device 120 from the management server 140. The information is set for each copy unit (MCU) as a unit of the copy process.

For example, even in the same content A, the copy unit is set in accordance with the copy destination media. That is, the setting is as below:

copy unit 0001 of content A with respect to hard disk

copy unit 0002 of content A with respect to flash memory

Furthermore, the server response information (Offer Response) 131 shown in FIG. 7 includes information stored on the managed copy manifest file (MCMF) 111 of the first media 110 described above by referring to FIG. 5. That is, the information is the copy data information (File name to be copied) (=dealManifest) (3). The copy process of the information is performed by prioritizing the information received from the management server 140. This is because the information received from the management server 140 may be sequentially updated.

Returning to FIG. 4, the sequence of the copy process of the content in accordance with the server management will be continued. In step S12, when the management server 140 performs the verification process of the validity or the like of the received information such as the content ID received from the information processing device 120, and when it is checked that there is no problem, the management server creates the server response information (Offer Response) 131 and transmits the server response information to the information processing device 120.

The information processing device 120 receiving the server response information (Offer Response) 131 displays the list (the copy permission list 121) of the copy permission content on the display unit of the information processing device 120 by applying the response information (Offer Response) 131 received from the management server 140. In this list, a price and the like are set when, for example, the copy process of each content item is performed.

In step S13, the user performs content selection for designating the content or the like as the copy object from the copy permission content list. Furthermore, in step S14, the information processing device 120 performs a payment process with the copy process between the user and the management server 140. Specifically, payment data 132 is transmitted between the information processing device 120 and the management server 140. Furthermore, the server performing the payment process may be a payment server different from the management server. Furthermore, when the content of which the copy process is free of charge is copied, the payment process is omitted.

After the optional payment process is completed, in step S15, the information processing device 120 transmits a request of the copy permission information to the management server 140. In step S16, the management server 140 checks whether the payment is performed in accordance with the copy permission request from the information processing device 120, creates the copy permission information 122, and transmits the copy permission information to the information processing device 120.

In step S17, the information processing device 120 performs the content copy process on the basis of the receipt of the copy permission information 122 from the management server 140. That is, the information processing device reads out the encrypted content 113 from the first media 110, performs a decoding process by selecting data as a copy object, and performs a copy process with respect to the second media 150 corresponding to a copy destination and configured as a hard disk (HDD), a flash memory, an R/RE disk, or the like.

Furthermore, the content copy process is performed in accordance with, for example, the following procedures.

(1) Reading encrypted content from first media 110 (copy source media)

(2) Decoding process of encrypted content in accordance with first management system corresponding to first media 110 (copy source media)

(3) Encryption process of content in accordance with second management system corresponding to second media 150 (copy destination media)

(4) Storage process of encrypted content with respect to second media 150 (copy destination media)

Likewise, when the encrypted content is read out from the disk and is copied to a media such as another disk, the encrypted content of the copy object is first decoded, and then a storage process is performed through re-encryption in accordance with the standard of the copyright management system corresponding to the copy destination media. Since such a process is performed, the use control of the copy destination media may be also realized, and the illegal use or distribution of the copy content may be prevented.

Furthermore, the content copyright management system for digital data is generally called a DRM (Digital Rights Management) system. Various media may store the digital data, and various DRM systems are adopted in accordance with the media. When the digital data is copied between media adopting different DRM systems, the DRM system adopted as the copy source media is changed to the DRM system adopted as the copy destination media, and the copy process is performed. With such a configuration, the illegal use or distribution of the copy content may be prevented.

In this case, when the management system (set as a first DRM) of the copy source and the content management system (set as a second DRM) of a copy destination are different from each other, it is necessary to first decode the encrypted content of the copy source as in the sequence of (1) to (4) and perform a storage process through a process in accordance with the management system (the second DRM) of the copy destination, for example, re-encryption or encoding using another encryption key.

The decoding process of the encrypted content in accordance with the first management system of (2) is performed as the decoding process by the unit of the CPS unit based on the CPS unit key when the first management system is a system configured in accordance with the AACS standard.

Furthermore, the second management system corresponding to the copy destination media (the second media 150) may be the AACS, and also the management system corresponding to various standards such as CPRM, MagicGate, and VCPS may be supposed.

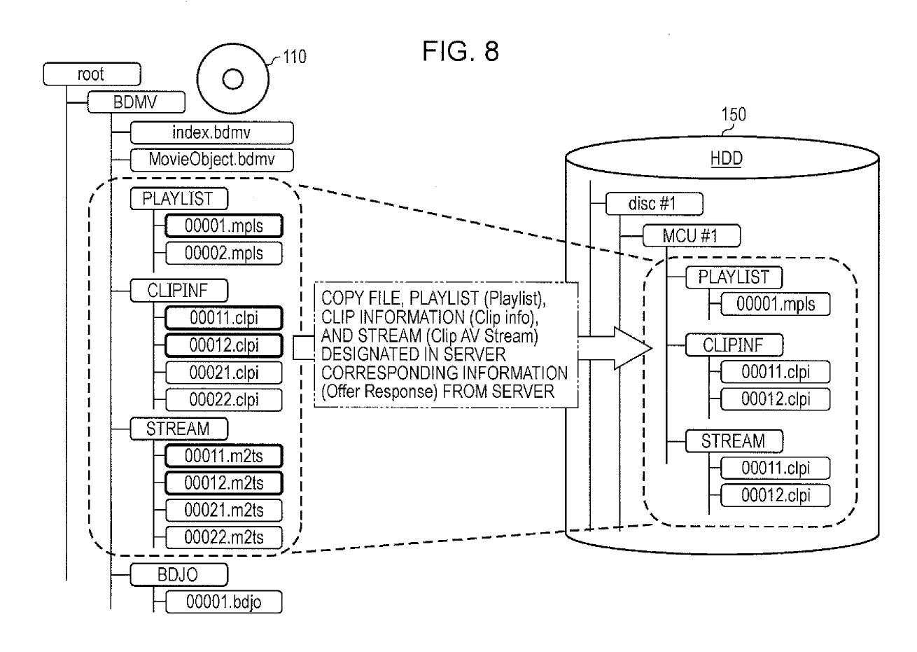

The specific copy example is shown in FIG. 8. FIG. 8 illustrates a first media 110 serving as a copy source and a second media 150 serving as a copy destination, for example, a hard disk (HDD).

As shown in the left side of FIG. 8, the first media 110 stores various files in accordance with the configuration of the directory described above by referring to FIG. 3. A process is performed in which a specific file is selected from a plurality of files and only the selected file is copied to the hard disk (HDD) as the second media 150.

An example is shown in which the file indicated by the thick line is selected from the directory of the first media 110 shown at the left side of FIG. 8. That is, the playlist file (PLAYLIST): 00001.mpls, the clip information file (CLIPINF): 00011.clpi, 00012.clpi, and the AV stream file: 0011.m2ts, 0012m2ts are selected and copied.

Likewise, for example, in the copy process, the management information file such as the index file or the movie object file is not copied, but only the playlist file to the AV stream file are stored.

Furthermore, the file selection is performed by applying the information included in the server response information (Offer Response) 131 described above by referring to FIG. 7.

As described above by referring to FIG. 7, the server response information (Offer Response) 131 stores information (3) the copy data information (File name to be copied) (=dealManifest) such as (3a) Playlist file name, (3b) CPS unit key information, and (3c) Copy unit identifier (MCUi).

Such information is stored, the copy unit as the unit of the copy is selected by applying the information, and the playlist file is acquired by acquiring the playlist file name corresponding to the selected copied unit. Further, the clip information file or the clip AV stream file designated by the acquired playlist file is acquired. Furthermore, the decoding process of the content such as the clip AV stream file is performed by acquiring the CPS unit key corresponding to the copy unit. Subsequently, the encryption process or the like corresponding to the DRM system of the second media 150 is performed, and the file is set in the hard disk (HDD) as the second media 150.

### [4. Network Transmission Process of Content]

As described above, even the use control content may be subjected to the managed copy process (MC) under the management of the server, and the user may reproduce or use the content in the second media serving as the copy destination media.

As a specific example of using the content, as described above, for example, a case may be exemplified in which a recording and reproducing device including a hard disk storing content is set as a home server and the content is reproduced by being transmitted to a client device, for example, a display device such as a TV installed at various rooms in a home via a home network.

This is a process in which the recording device serving as the home server reads out the content from the hard disk storing the content and the content is reproduced by being transmitted to the TV or the like in another room via the home network. The device such as a TV used to reproduce the content performs, for example, the reproducing device according to the specification of the DLNA (Digital Living Network Alliance) and performs a process by analyzing a command or the like in accordance with the DLNA standard.

As described above, for example, the content stored on a BD-ROM may have a specific reproduction function. For example, the specific reproduction function may be reproduction by the unit of a chapter (a predetermined reproduction section) set as content such as a movie. Specifically, there is content which is reproduced after skipping to a specific chapter using chapter information including a chapter start point and the like or content having a voice/subtitle selection function of optionally reproducing a plurality of voices or subtitles. The content performs, for example, the skip reproduction and the voice/subtitle selection output in accordance with the selection information or the command input from the user.

The control information for realizing such reproduction function is stored on a reproduction control information file (for example, a playlist file, a clip information file, and the like) of the original content. Accordingly, in the device capable of analyzing and reproducing the reproduction control information file (for example, the playlist file, the clip information file, and the like), the specific reproduction function may be used without any problem. However, for example, in the device transmitting the content in accordance with the DLNA standard, the above-described reproduction control information (for example, the playlist file, the clip information file, or the like) may not be correctly analyzed. In this case, such a device may not use the chapter skip function and the audio/subtitle selection reproduction function.

Hereinafter, the configuration for preventing such events will be described.

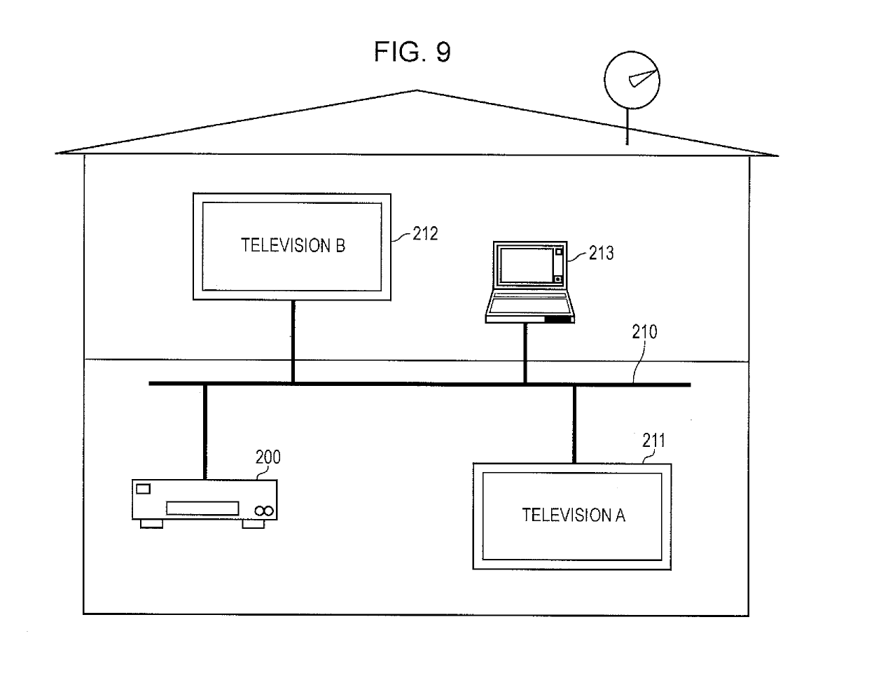

First, referring to FIG. 9, an example of using the information processing device of the disclosure will be described.

FIG. 9 is a diagram illustrating a configuration example of the home network. As an example thereof, the home network according to the DLNA (Digital Living Network Alliance) will be described. The devices connected to the home network may communicate with each other using, for example, the UPnP (Universal Plug and Play) protocol.

In the network configuration shown in FIG. 9, the information processing device 200 includes a hard disk, and stores the copy content copied in accordance with the above-described managed copy (MC) on the hard disk. The information processing device 200 is a device corresponding to the information processing device 20 shown in FIG. 1 or the information processing device 120 shown in FIG. 4.

The information processing device 200 is connected to a television A211, a television B212, and a PC 213 via a network 210, and the respective devices perform a communication via the network 210. Such a network connection device is a DLNA device (DLNA client) capable of transmitting and receiving data or reproducing data in accordance with the specification of the DLNA.

The information processing device 200 serves as a home server (DLNA server) transmitting the content to the DLNA client. The information processing device 200 serving as the home server transmits (for example, streaming-transmits) the content stored on the hard disk to the device (the client) via the network 210 in accordance with the operation of the television A211, the television B212, and the PC 213 manipulated by the user.

Furthermore, in the embodiment below, an example will be described in which the copy content stored on the hard disk is transmitted, but the same process may be performed even when not the copy content, but the content stored on the first media such as a BD is read and transmitted.

The user manipulating the television A211, the television B212, and the PC 213 may perform processes such as a reproduction start, a stop, a skip, a voice selection, and a subtitle setting of the content via an input section or a remote controller of the device.

However, the television A211, the television B212, and the PC 213 used to reproduce the content have a function of performing a process by analyzing the control information in accordance with the DLNA standard, but it is not possible to guarantee the analysis and the process of the control information not corresponding to the DLNA standard.

For example, the hard disk of the information processing device 200 serving as the home server stores not only the AV stream file as the reproduction control data, but also the playlist file or the clip information file as the reproduction control information file. The playlist file or the clip information file stores control information relating to the output of the chapter information and the voice/subtitle output control.

However, in some cases, even when the playlist file or the clip information file is transmitted to the reproducing device (the client (DLNA Client)) such as a TV via a network, the reproducing device (the client) may not analyze and use the control information stored on the reproduction control information file. In this case, the output process of the chapter information, the voice/subtitle selection process, or the like may not be performed.

In order to avoid such events, the information processing device 200 of the disclosure performs a process in which the reproduction control information stored on the reproduction control information file such as the playlist file corresponding to the content is usable in the reproducing device (the client (for example, the DLNA device)) connected to the home network.

Specifically, for example, the control information is transmitted by being converted into a data format which may be processed in the DLNA client. Alternatively, a process is performed in which the content in accordance with the control information stored on the playlist file or the like may be reproduced in the client device through the mutual communication between the information processing device 200 as the home server and the client device (the reproducing device).

In terms of such a process, the client device on the home network may reproduce the content received from the home server (the information processing device 200) as in the case where the reproduction control information file (the playlist file or the clip information file) corresponding to the content stored on the media (an HDD or the like) is used.

Hereinafter, an example of a process in which a plurality of reproduction control information items is used by the information processing device 200 of the disclosure will be sequentially described in accordance with the following information.

(a) Chapter information

(b) Voice/subtitle selection information

(4-1. (a) Conversion process of chapter information)

There is a chapter function of starting a reproduction process from a skipped selection chapter using, for example, chapter information including information of a start point of a chapter (a predetermined reproduction section) set in the content such as a movie.

In order to skip to the reproduction start point of a predetermined chapter (divided reproduction section) in the content and reproduce the content, the start point information of each chapter set in the content is necessary.

For example, the chapter start point information is stored on the playlist file as the reproduction control information file set as the content stored on a BD-ROM.

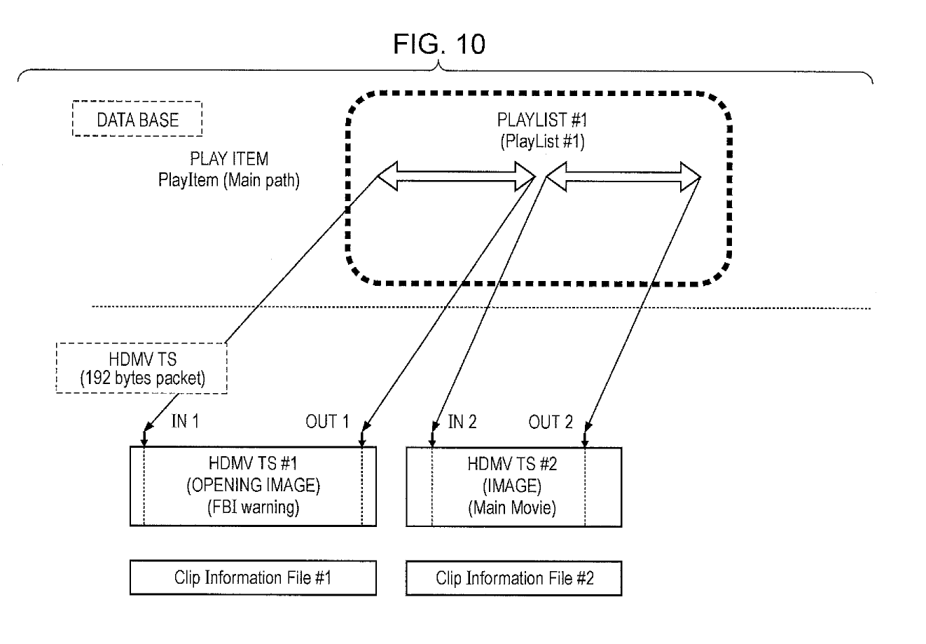

The playlist file will be described by referring to FIG. 10.

FIG. 10 illustrates a content reproduction process example using a playlist file #1.

For example, a specific playlist is selected in accordance with the title designated by the user for reproduction thereof, and the reproduction process is performed by selecting a clip (a clip information file and a clip AV stream file) in accordance with the playlist.

The playlist file #1 shown in FIG. 10 is an example of the playlist having the simplest configuration. A play item including reproduction designation information representing the reproduction start position and the reproduction end position with respect to the clip information file of the video content is set. The play item includes two play items.

The two play items are a first play item including a reproduction start point (IN1) and a reproduction end point (OUT1) of an opening video and a second play item including a reproduction start point (IN2) and a reproduction end point (OUT2) of a feature presentation.

For example, when the playlist file #1 is selected in accordance with the title designated by the user for the reproduction thereof, the clip (the clip information file and the clip AV stream file) having an opening video is selected and reproduced in accordance with the play item precedent to the playlist file #1, and then the clip (the clip information file and the clip AV stream file) of the feature presentation is selected and reproduced in accordance with the subsequent play item.

The structure of the playlist file is not limited to the file having a simple structure as in the playlist file #1 shown in FIG. 10. There is a playlist file having a complex structure for performing various complex data reproduction processes.

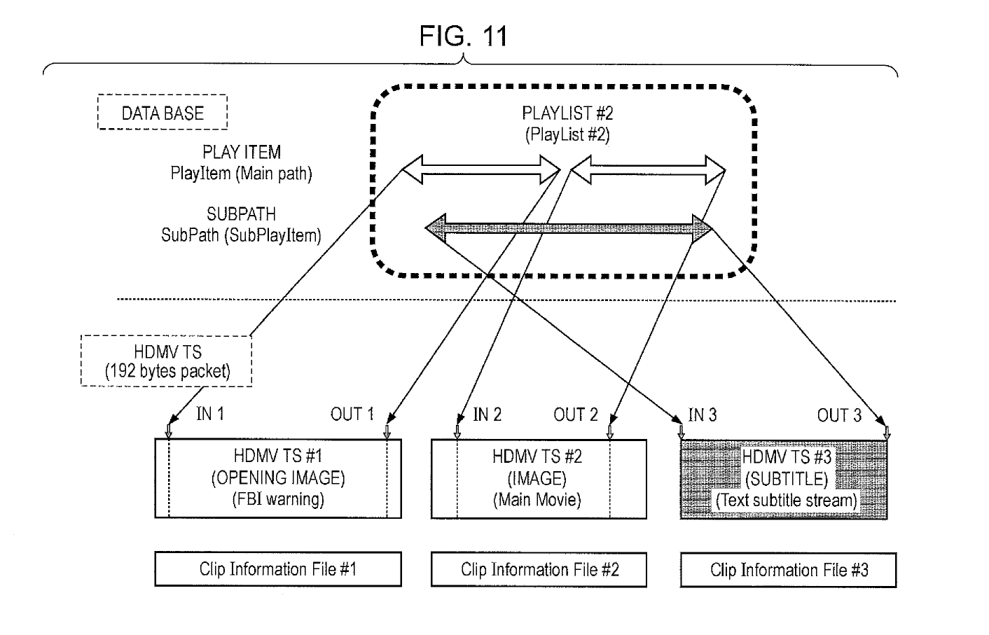

As an example of the playlist file realizing complex data reproduction, an example of the playlist file having a subpath will be described by referring to FIG. 11.

In a playlist file #2 shown in FIG. 11, a play item including reproduction designation information representing the reproduction start position and the reproduction end position for the clip information file of the video content and a subpath including a subtitle reproduction designation information are set. The play item includes two play items.

The two play items are a first play item including a reproduction start point (IN1) and a reproduction end point (OUT1) of an opening video and a second play item including a reproduction start point (IN2) and a reproduction end point (OUT2) of a feature presentation.

The subpath includes information with a reproduction start point (IN3) and a reproduction end point (OUT3) of subtitle data.

For example, when the subtitle data designated by the subpath is Japanese subtitles, image content is reproduced from the clip information file designated by the play item of the playlist #2, and also the subtitle data is reproduced from the clip storing subtitle data selected by the subpath.

For example, when English subtitles are displayed, a different playlist is used.

Likewise, when the playlist file includes a play item corresponding to a main path and a subpath, the reproduction process using two path information items may be performed, and for example, the subtitles are reproduced along with the reproducing video.

Furthermore, the playlist file stores a file with a subpath as shown in FIG. 11 and a file without a subpath as shown in FIG. 10, and the media such as a BD storing the original content stores a plurality of different playlist files. The playlist file as the copied data is stored even in the information processing device 200 shown in FIG. 9 and corresponds to the storage destination of the copy content.

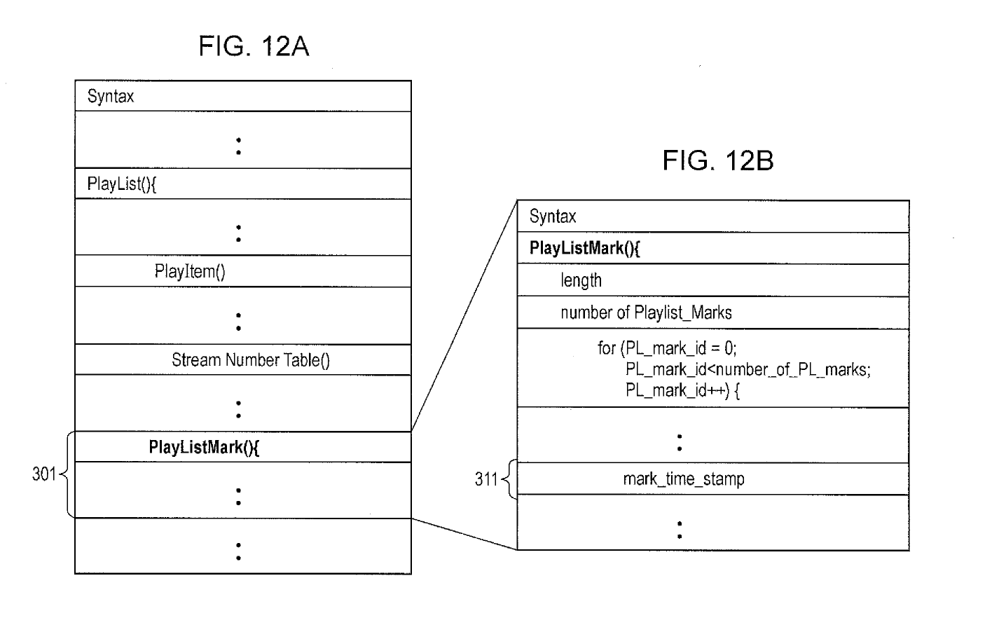

Next, the syntax (data structure) of the playlist file will be schematically described by referring to FIGS. 12A and 12B.

FIG. 12A is a diagram illustrating the entire playlist file, and FIG. 12B is a diagram illustrating a syntax (data structure) of a playlist mark which is a part of the playlist file.

Furthermore, the syntax shown in FIGS. 12A and 12B mainly illustrates only the part relating to the disclosure.

In the playlist file shown in FIG. 12A, the play item (Play_Item) field storing information on the above-described play item is set, and a playlist mark (PlayList_Mark) field 301 storing information on the start point and the like of the chapter (divided reproduction section) is further set.

FIG. 12B is a syntax of a playlist mark (PlayList_Mark) field 301.

In the playlist mark (PlayList_Mark) field 301, chapter information as control information relating to each chapter set with respect to an AV stream file subjected to the reproduction control by the playlist file is stored.

When a plurality of chapters is set, chapter information is sequentially stored with respect to each chapter.

As one type of chapter information stored on the playlist mark (PlayList_Mark) field 301, there is time information (reproduction time information) representing the start position of the chapter. This is the mark timestamp (Mark_Time_Stamp) shown in FIG. 12B.

The mark timestamp (Mark_Time_Stamp) is a field that stores reproduction time information of the start position of the chapter.

Each playlist file stores the timestamp representing the start point of each chapter (Mark #1, #2, #3, . . . ) included in the clip (the clip information file/the clip AV stream file) designated by the playlist file.

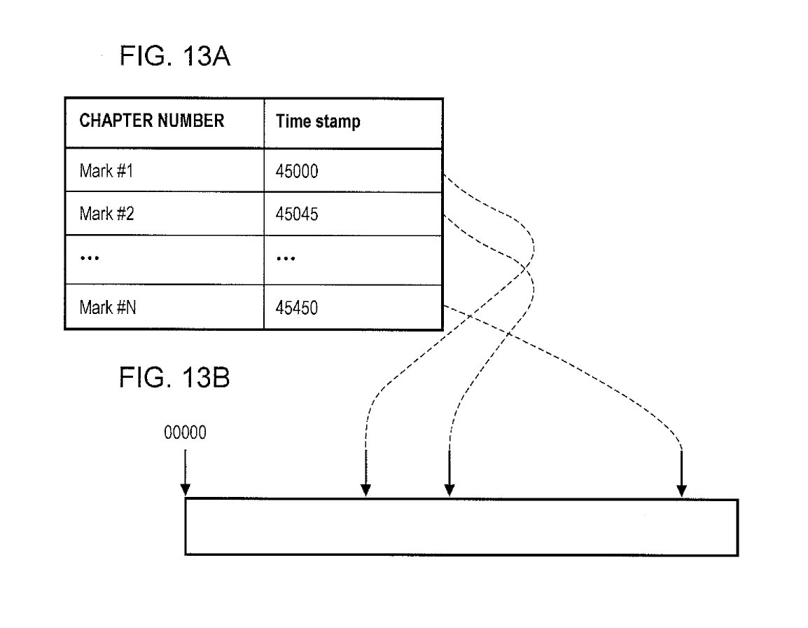

A correlation example between the setting example of the mark timestamp as the chapter information stored on the playlist file and the AV stream will be described by referring to FIGS. 13A and 13B.

FIG. 13A illustrates data of the chapter information of the playlist file, and FIG. 13B illustrates data of the clip AV stream.

FIG. 13A is a diagram illustrating the chapter information of the playlist file, where the timestamp (=the mark timestamp) in chapter information stored on a playlist file is shown as a list. In the playlist file shown in the drawing, the timestamp as the chapter reproduction start time information corresponding to N chapters is stored.

That is, the following information is stored.
chapter Mark#1: timestamp=45000
chapter Mark#2: timestamp=45045
   :
chapter Mark#N: timestamp=45450

The timestamp represents the reproduction time of the chapter start position. In the timestamp, the head of the clip AV stream file shown in FIG. 13B is set to the reproduction start time “00000”, and the reproduction time information is “45000”, “45045”, . . . “45450” when measured with a predetermined clock (for example, 90 Hz clock).

When the content reproducing device reproduces content by using a reproduction program capable of analyzing reproduction time information of the playlist file, it is possible to perform the reproduction, for example, the skip reproduction in which the reproduction start point is set as the position of each timestamp in accordance with the request (input command) from the user.

However, as described above, for example, the client device (for example, the DLNA client) connected to the home network may not analyze the meaning of the timestamp.

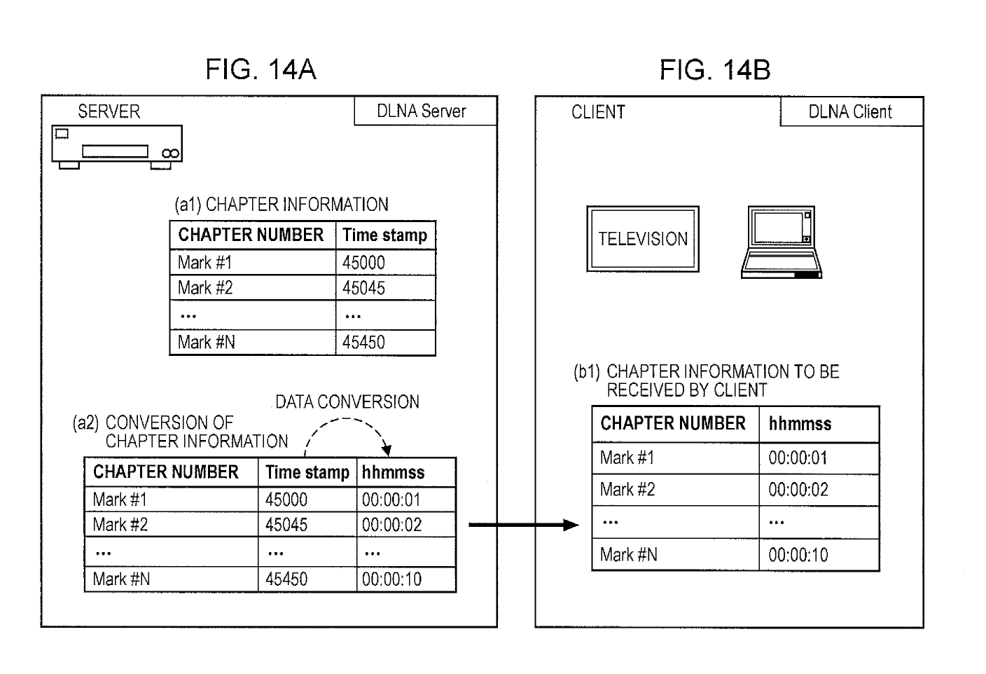

Therefore, the information processing device 200 serving as the server transmitting the content to the information processing device 200 of the disclosure, that is, the client device converts the timestamp representing the chapter start position into time information (hours/minutes/seconds) understandable by the client device, and provides the converted time information (hours/minutes/seconds) to the client device. This process will be described by referring to FIGS. 14A and 14B.

FIG. 14A illustrates the server performing a transmission process of the content, and FIG. 14B illustrates the client receiving and reproducing the content.

The server of FIG. 14A is, for example, the information processing device 200 shown in FIG. 9.

The client of FIG. 14B is, for example, the television A211, the television B212, the PC 213, and the like shown in FIG. 9.

The information processing device 200 serving as the server transmitting the content reads out the content from the hard disk storing the copy content, and provides the content for the client. In the hard disk, the playlist file as the reproduction control information file is stored. Then, in the playlist file, as described above by referring to FIGS. 12A and 12B and 13A and 13B, the timestamp as the reproduction time information representing the chapter start position is stored. This is the list shown in FIG. 14A1.

The information processing device 200 serving as the server transmitting the content converts the timestamp (the mark timestamp) in the chapter information of the playlist file read out from the hard disk into time information expressed by the hours, minutes, and seconds.

As described above by referring to FIGS. 13A and 13B, the timestamp representing the chapter start point stored on the playlist file is a count value obtained by measuring the reproduction time of each chapter start position with the condition that the start point of the clip AV stream is set to “reproduction time=00000” and a specific frequency clock (for example, 90 Hz clock) is applied.

The information processing device 200 calculates the timestamp in the condition that the start point of the clip AV stream is set as “reproduction time=00 hours, 00 minutes, 00 seconds” and the reproduction time information of each chapter start position is “reproduction time=hh hours, mm minutes, ss seconds”.

This process example is shown in FIG. 14A2.

That is, the conversion process of the reproduction time information below is performed.

Chapter Mark#1: timestamp=45000→reproduction time (hhmmss)=00:00:01

Chapter Mark#2: timestamp=45045→reproduction time (hhmmss)=00:00:02
:

Chapter Mark#N: timestamp=45450→reproduction time (hhmmss)=00:00:10

Likewise, the information processing device 200 serving as the server transmitting the content converts the timestamp representing the chapter start point stored on the playlist file into real-time information expressed by the units of hours, minutes, and seconds.

The time information (hhmmss) expressed by the units of hours, minutes, and seconds is, for example, information that is analyzable by the DLNA device corresponding to the DLNA standard, and the client device may reliably acquire the reproduction time as the chapter start position by referring to the real-time information.

The information processing device 200 serving as the server transmitting the content provides the AV stream file as the reproduction object content and the converted chapter information for the client via a network.

The chapter information received by the client is, for example, data shown in FIG. 14B1. The client device may acquire the reproduction time as the chapter start position by referring to the real-time information, and perform a skip reproduction or the like from each chapter start position.

Furthermore, time information (hhmmss) is defined in the DLNA standard, and may be analyzed in the DLNA device. Accordingly, the reproducing device (DLNA client) receiving and reproducing the content received from the information processing device 200 as the home server via the network may detect the reproduction time of each chapter by referring to the time information (hhmmss) received from the server.

For example, when the user manipulating the reproducing device (DLNA client) requests a chapter skip process via the input section or the remote controller, the data processing section of the reproducing device detects the chapter closest to the current reproduction time by performing, for example, the a time search (DLNA TimeSearch) function defined in the DLNA standard.

When the data processing section of the reproducing device receives a forward skip (SkiptoPrevious) request from the user, the data processing section acquires the time information (hhmmss) of the chapter start position of the precedent chapter from the current reproduction position on the basis of the chapter information shown in FIG. 14B1. When the data processing section receives the rearward skip (SkiptoNext) request from the user, the data processing section acquires the time information (hhmmss) of the chapter start position of the next chapter from the current reproduction position on the basis of the chapter information shown in FIG. 14B1. Furthermore, for example, by performing the time search (DLNA TimeSearch) function defined in the DLNA standard, the reproduction start position is moved to the position corresponding to the time information (hhmmss). According to this process, it is possible to perform the same process as the chapter skip process.

Likewise, the information processing device 200 serving as the server provides the timestamp included in the chapter information into the time information (hhmmss) understandable by the client. According to this process, the reproducing device serving as the client may perform the reproduction process such as a chapter skip without any problem through the search process based on the time information (hhmmss) using the time information (hhmmss) understandable by the client.

### (4-2. (b) Conversion Process of Voice/Subtitle Selection Information)

Next, a process will be described in the case where the content provided for the client device from the information processing device 200 serving as the server is content capable of selecting a voice or a subtitle.

Specifically, for example, it is the content in which the English voice, the Japanese voice, and the like are set as voice information, the English subtitles, the Japanese subtitles, and the like are set as the subtitle information, and the plurality of voice information items and subtitle information items is selectively reproduced by the user.

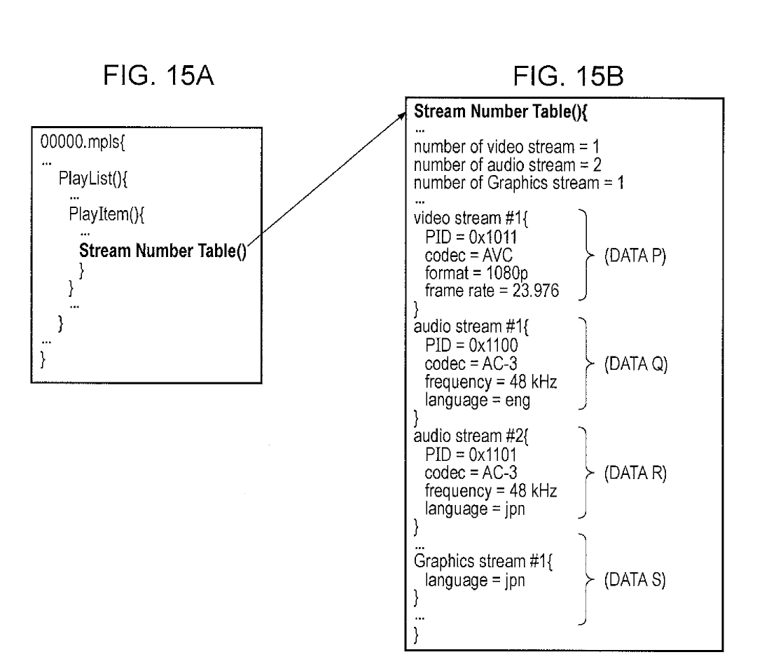

A configuration example of the playlist file as the reproduction control information file set to correspond to the content will be described by referring to FIGS. 15A and 15B.

FIG. 15A illustrates the syntax of the playlist file, and FIG. 15B illustrates the syntax of the stream number table (STN_table) included in the playlist file.

The correlation data between the attribute of the voice or the subtitles and the specific meaning (language) is stored on the stream number table (STN_table) inside the playlist file.

In the stream number table (STN table), voice/subtitles stream information reproduced by the play item included in the playlist is stored. The stream information includes the stream number, the packet ID (PID), the language type, the number of channels, the codec information, and the like.

The stream number table (STN_table) shown in FIG. 15B is an example showing information relating to four data.

(data P) video stream (movie)

(data Q) voice stream (English voice)

(data R) voice stream (Japanese voice)

(data S) subtitles stream (Japanese subtitles)

When the respective streams are reproduced in combination, for example, the content with the following setting may be reproduced.

(1) Main Movie in English (data P+Q)

(2) Main Movie in Japanese (data P+R)

(3) Main Movie in English w/Japanese subtitles (data P+Q+S)

The information processing device 200 serving as the server transmitting the content transmits the information extracted from the stream number table (STN_table) included in the playlist file shown in FIG. 15B to the reproducing device (the client) via the network.

The reproducing device (the client) outputs the selection screen (the user interface (UI)) for selecting the voice or the subtitles in the reproducing device (the client device) on the basis of the storage information of the stream number table (STN_table).

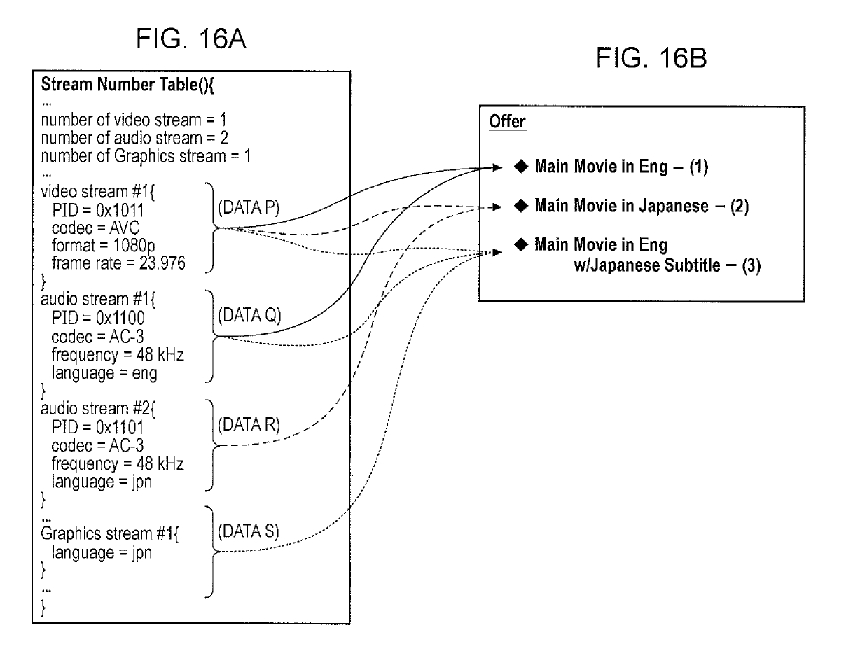

FIGS. 16A and 16B illustrate an example of UI displayed on the client device. FIG. 16A illustrates the data of the reproduction control information (STN) transmitted from the server to the client, and FIG. 16B illustrates the data of the selection information (UI) output from the client.

The reproduction control information (STN) shown in FIG. 16A and transmitted from the server to the client is information extracted from the stream number table (STN_table) included in the playlist file by the information processing device 200 serving as the server, and is information shown in FIG. 15B.

The reproducing device (the client device) displays the selection information (UI) reproduction data shown in FIG. 16B on the display unit in accordance with the information received from the server.

The example of the selection information (UI) shown in FIG. 16B has the following setting.

(1) Main Movie in English

(2) Main Movie in Japanese

(3) Main Movie in English w/Japanese subtitles

The user selects the desired reproduction content in accordance with the output of the selection information (UI) of the reproduction data shown in FIG. 16B.

That is, several content items of (1) to (3) are selected as the desired reproduction content. For example, the selection information is input using the remote controller corresponding to the reproducing device.

When the data processing section of the reproducing device (the client) detects an input of the selection information (any one of (1) to (3)) from the user, the data processing section transmits the selection information to the server.

Furthermore, the selection information is the selection information of data stored on the STN table transmitted from the server to the client and for example, the following selection information is transmitted.

(1) In the case of Main Movie in English, selection information=(data P+Q)

(2) In the case of Main Movie in Japanese, selection information=(data P+R)

(3) In the case of Main Movie in English w/Japanese subtitles, selection information=(data P+Q+S)

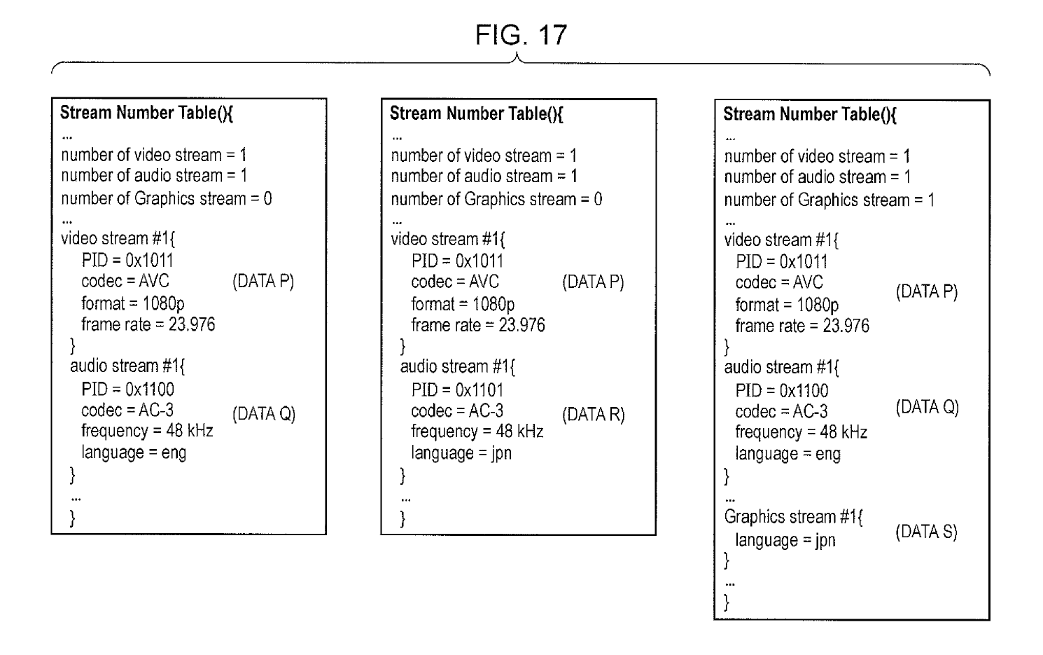

FIG. 17 illustrates a transmission example in which the selection information based on the user's selection of (1) to (3) is transmitted from the client to the server.

Furthermore, the information transmitted from the client to the server may be the storage information of the STN_table, or the identification information representing the selection of the data.

The information processing device 200 serving as the server sets the reproduction content as the reproduction content items of several settings of (1) to (3) in accordance with the transmission information from the client, and transmits the reproduction content to the client.

When the information processing device 200 serving as the server receives the “data P+Q” shown in FIG. 17(1) or the identification information representing the selection of the data, the server transmits the content reproduced according to the play item of the playlist selected in accordance with the STN table, that is, (1) Main Movie in English to the client as the transmission content.

According to this process, the reproducing device of the client may receive and reproduce the movie in English voice from the server.

Further, when the information processing device 200 receives “data P+R” shown in FIG. 17(2) or the identification information representing the selection of the data, the server transmits the content reproduced according to the play item of the playlist selected in accordance with the STN table, that is, (2) Main Movie in Japanese to the client as the transmission content.

According to this process, the reproducing device of the client may receive and reproduce the movie in Japanese voice from the server.

Furthermore, when the information processing device 200 receives “data P+Q+S” shown in FIG. 17(3) or the identification information representing the selection of the data, the server transmits the content reproduced according to the play item of the playlist selected in accordance with the STN table, that is, (3) Main Movie in English w/Japanese subtitles to the client as the transmission content.

According to this process, the reproducing device of the client may receive and reproduce the movie in English w/Japanese subtitles from the server.

### [5. Sequence of Process Performed by Information Processing Device]

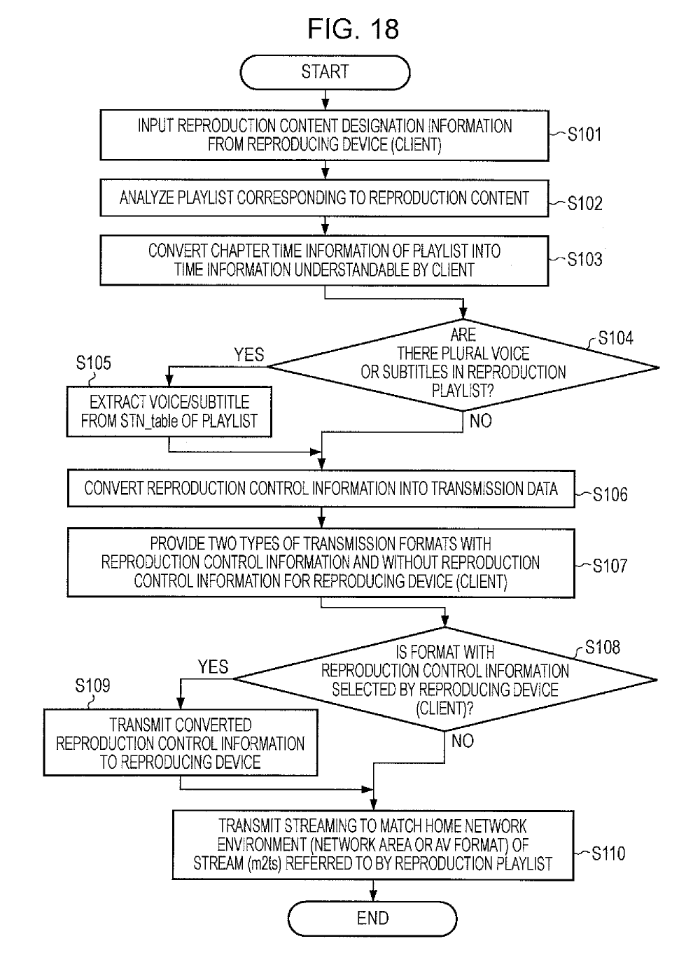

Next, referring to the flowchart shown in FIG. 18, the sequence of the information processing device serving as the server transmitting the content and the sequence of the information processing device serving as the client receiving and reproducing the content will be described.

First, referring to the flowchart shown in FIG. 18, the process performed by the information processing device serving as the server transmitting the content will be described.

The process of each of the steps below step S101 of the flowchart shown in FIG. 18 will be described. Furthermore, the process of each step shown in the flowchart is performed by the data processing section of the information processing device serving as the server transmitting the content.

First, in step S101, the reproducing content designation information is input from the reproducing device (the client). This is an input from, for example, the reproducing device (the client) connected to the network such as the home network.

Next, in step S102, the information processing device transmitting the content analyzes the playlist file as the reproduction control information file corresponding to the reproduction content designated by the client.

Next, in step S103, the chapter time information of the playlist is converted into the time information understandable by the client.

This process is the process described above by referring to FIGS. 12A to 14B. The timestamp (the mark timestamp) in the chapter information of the playlist file is converted into the time information (hhmmss) expressed by the units of hours, minutes, and seconds.

Next, in step S104, the information processing device transmitting the content determines whether there are a plurality of reproducible voice items or subtitles in the playlist as the reproduction control information file corresponding to the reproduction content designated by the client. When there are a plurality of reproducible voice items or subtitles in the playlist, the current process proceeds to step S105. When there is no reproducible voice or subtitles, the current process proceeds to step S106.

When there are a plurality of reproducible voice items or subtitles in the playlist, the process proceeds to step S105, and voice/subtitle information is extracted from the stream number table (STN_table) of the playlist file.

This process is the process described above by referring to FIGS. 15A and 15B. As described above by referring to FIGS. 15A and 15B, the stream number table (STN table) stores the stream information of the voice or the subtitles reproduced by the play item included in the playlist. The stream information includes the stream number, the packet ID (PID), the language type, the number of channels, the codec information, and the like. In step S105, such information is extracted.

Next, in step S106, the reproduction control information extracted from the reproduction control information file such as the playlist file is converted into a predetermined transmission data format.

Next, in step S107, the information processing device (the server) transmitting the content asks the reproducing device (the client) if the reproduction control information file with respect to the AV stream data as the reproduction object data is necessary. As the process determining the necessity, the information processing device transmits two types of transmission data, that is, the data with the reproduction control information and the data without the reproduction control information.

When the reproducing device (the client) receives two types of data, the reproducing device selects any one of them as the process object data, and returns the selection information to the information processing device (the server) transmitting the content.

Furthermore, when the reproducing device (the client) selects the data with the reproduction control information, the reproducing device first provides the voice/subtitle selection information described by referring to FIGS. 15A to 17 for the server. For example, the following selection information described by referring to FIGS. 15A to 17 is transmitted.

(1) In the case of Main Movie in English, selection information=(data P+Q)

(2) In the case of Main Movie in Japanese, selection information=(data P+R)

(3) In the case of Main Movie in English w/Japanese subtitles, selection information=(data P+Q+S)

Next, in step S108, the information processing device (the server) determines whether the reproducing device (the client) selects the transmission data with the reproduction control information.

When the reproducing device (the client) selects the transmission data with the reproduction control information, the current process proceeds to step S109, and the control information converted into the data understandable by the client is transmitted to the reproducing device (the client).

The converted reproduction control information is data including, for example, data obtained by converting the timestamp (the mark timestamp) of the chapter information of the playlist file into the time information (hhmmss) expressed by the units of hours, minutes, and seconds.

After the converted control information is transmitted in step S109 or when the reproducing device (the client) selects the transmission data without the reproduction control information in step S108, the current process proceeds to step S110.

In step S110, the referred stream (m2ts) of the reproduction playlist is streaming-transmitted while matching the environment (the network band or the AV format) of the home network.

Furthermore, during the content transmission process, the server selects and provides the transmission content in accordance with the selection information received from the client in step S107.

For example, the streaming-transmission of any one of data of (1) Main Movie in English, (2) Main Movie in Japanese, and (3) Main Movie in English w/Japanese subtitles is performed in accordance with the designation from the client.

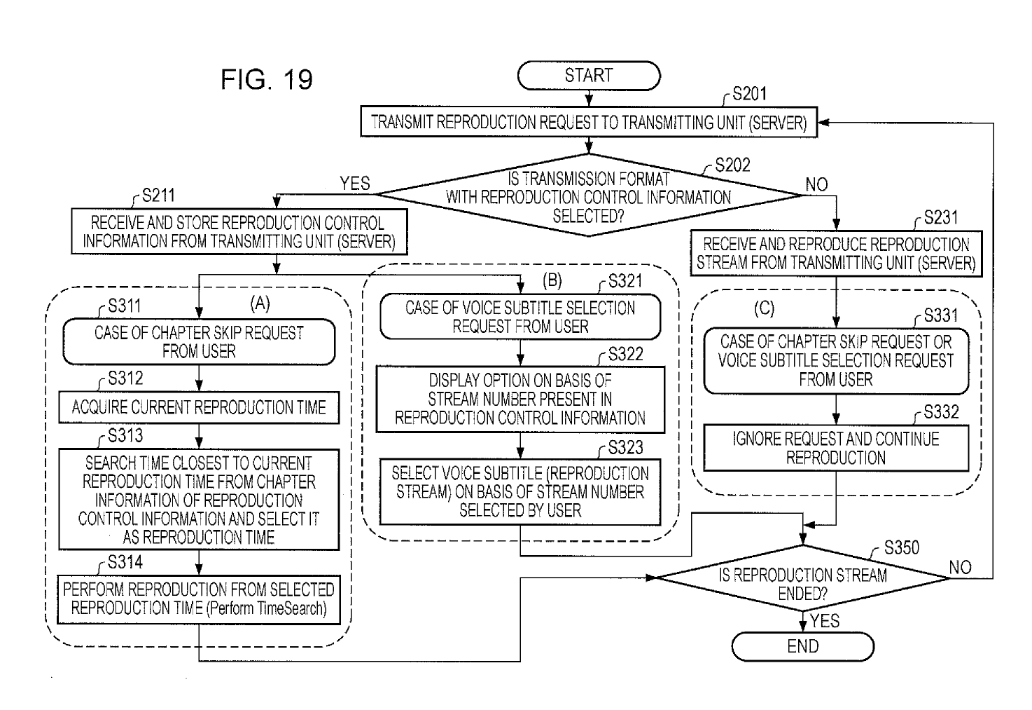

Next, referring to FIG. 19, the sequence of the process performed by the information processing device serving as the client receiving and reproducing the content will be described.

The process of each of the steps below step S201 of the flowchart shown in FIG. 19 will be described. Furthermore, the process of each step shown in the flowchart is performed by the data processing section of the image processing device serving as the client receiving and reproducing the content.

First, in step S201, the reproducing device (the client) transmits the reproducing content designation information to the transmitting device (the server). This is a transmission to, for example, the transmitting device (the server) connected to the network such as the home network.

Furthermore, each of the processes of step S101 to step S108 shown in FIG. 18 is performed between step S201 to step S202.

The process below step S202 is different from the process when selecting the transmission format with the reproduction control information by the reproducing device (the client) and the process when selecting the transmission format without the reproduction control information by the reproducing device (the client) in step S108 shown in FIG. 18.

In step S202, when it is determined that the reproducing device (the client) selects the transmission format with the reproduction control information, the current process proceeds to step S211. Then, the reproducing device receives the reproduction control information from the transmitting device (the server), and stores the reproduction control information on the memory of the reproducing device (the client).

This process corresponds to the process of receiving and storing the data transmitted from the transmitting device (the server) in step S109 of FIG. 18.

On the other hand, in step S202, when it is determined that the reproducing device (the client) selects the transmission format without the reproduction control information, the current process proceeds to step S231. Then, the reproducing device receives and reproduces the reproduction stream transmitted from the transmitting device (the server). This process is the stream reproduction process not based on the control information.

This process corresponds to the process of receiving and reproducing the AV stream from the transmitting device (the server) in step S110 after “No” of step S108 of FIG. 18.

The subsequent process is the process of the reproducing device (the client) according to the process request input from the user.

When it is determined that the transmission format with the reproduction control information is selected and the current process proceeds to step S211, the following processes (A) and (B) are performed in accordance with the user request.

(A) S311 for case of chapter skip request input from user

(B) S321 for case of voice/subtitle selection request input from user

On the other hand, when it is determined that the transmission format without the reproduction control information is selected and the current process proceeds to step S221, the following process (C) is performed.

(C) S331 for case of chapter skip request or voice/subtitle selection request input from user

First, the process (C) will be described.

It is determined that the reproducing device (the client) selects the transmission format without the reproduction control information, and the current process proceeds to step S221.

The stream reproduction of the content is already started in the (C) S331 for case of chapter skip request or voice/subtitle selection request input from user. Then, in step S332, the user request is ignored, and the content reproduction is directly performed.

This process is the content reproduction process in which the reproduction control information is not basically applied.

Next, the process (A) will be described.

It is determined that the reproducing device (the client) selects the transmission format with the reproduction control information, and the current process proceeds to step S211.

The process is performed in the (A) S311 for case of chapter skip request input from user.

Furthermore, the process (A) is performed after the reproduction of the AV stream as the reproduction data is started.

In step S312, the reproducing device (the client) acquires the current reproduction time information. For example, the DLNA device stores the reproduction time information (hhmmss), obtained by expressing the elapsed time from the head of the stream by the units of hours, minutes, and seconds, on the memory when reproducing the content. The storage time is acquired as the reproduction time information.

Next, in step S313, the time closest to the current reproduction time is searched from the chapter information of the reproduction control information, and the time is selected as the reproduction time.

The chapter information is the chapter information which has described above by referring to FIG. 14B.

That is, it is the time information (hhmmss) which is obtained by converting the timestamp of the playlist file so as to be expressed by the units of hours, minutes, and seconds by the server serving as the content transmitting device.

Next, in step S314, the time search (TimeSearch) process is performed by applying the time information (hhmmss) correlated to the chapter designated in accordance with the chapter designation information included in the chapter skip request input from the user in step S311, and the reproduction process is performed from the reproduction time (hhmmss) corresponding to the searched time. In this process, the chapter skip process is consequently performed.

Next, the process (B) will be described.

It is determined that the reproducing device (the client) selects the transmission format with the reproduction control information, and the current process proceeds to step S211.

The process is performed in the (B) S321 for the case of voice/subtitle selection request from user.

Furthermore, the process (B) is performed before reproducing the AV stream as the reproduction data.

In step S322, the reproducing device (the client) displays options for the user on the basis of the stream number present in the reproduction control information.

This process is the process described above by referring to FIGS. 16A and 16B.

That is, the reproducing device (the client device) receives the information extracted by the server from the stream number table (STN_table) included in the playlist file, that is, the information relating to the voice or the subtitles (step S211), and the reproducing device (the client device) displays the selection information (UI) of the reproduction data shown in FIG. 16B on the display unit in accordance with the received information. This process is the process of step S322.

For example, the selection information (UI) shown in FIG. 16B, that is, the UI including (1) Main Movie in English, (2) Main Movie in Japanese, and (3) Main Movie in English w/Japanese subtitles is displayed on the display unit of the client.

Next, in step S323, the information selected by the user is provided for the server, and the server selects the transmission stream in accordance with the selection information and transmits the transmission stream. Furthermore, when the selection process is performed after starting the content reproduction, the server converts the transmission stream.

After the processes (A), (B), and (C), when it is determined that the process ends as a result of the determination of whether the reproduction stream ends in step S350, the process ends.

Furthermore, when the content is continuously reproduced, the current process returns to step S201, and the reproduction request is output to the server.

Likewise, according to the process of the disclosure, for example, even in the reproducing device such as the DLNA client that may not analyze the description of the control information file such as the playlist file, it is possible to perform the same process as the content reproduction process when the chapter information or the voice/subtitle information stored on the playlist file is used.

### [6. Configuration Example of Information Processing Device]

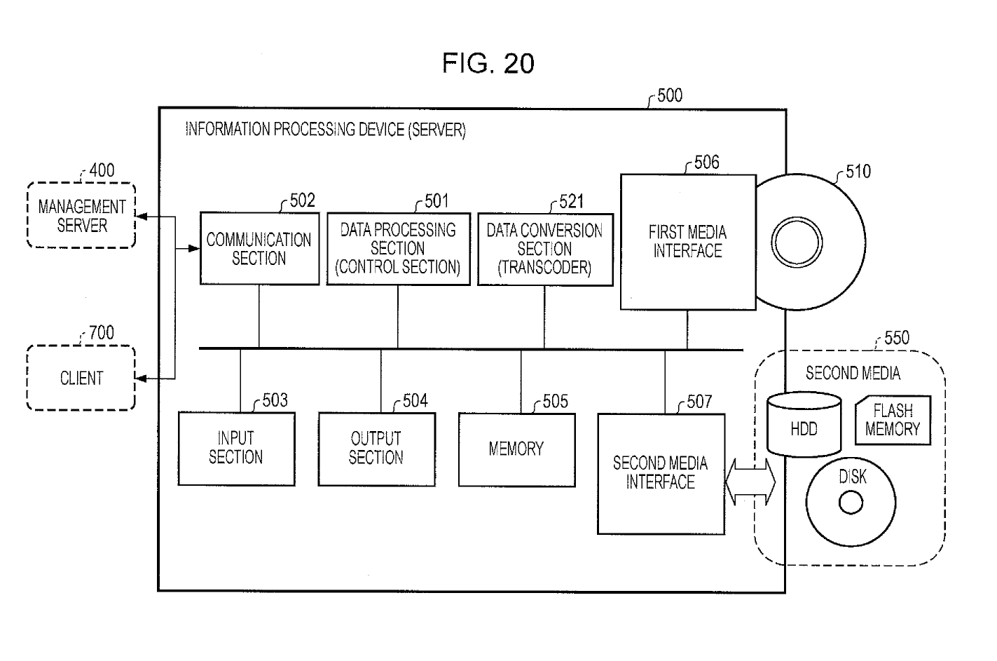

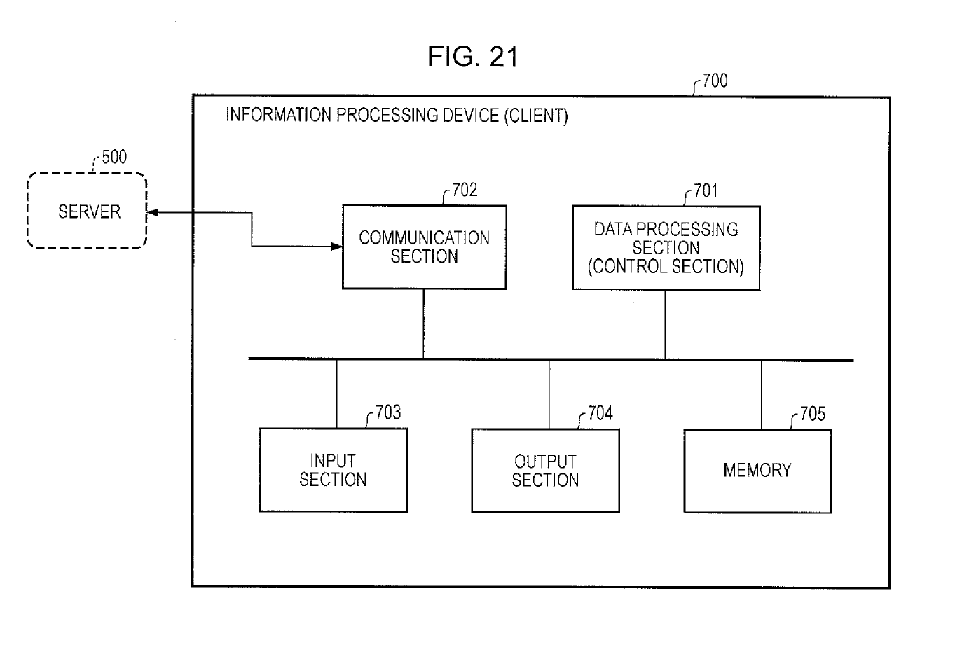

Finally, the configuration examples of the information processing device serving as the server transmitting the content and the information processing device serving as the client receiving and reproducing the content according to the embodiment of the disclosure will be described by referring to FIGS. 20 and 21.

First, referring to FIG. 20, the configuration example of an information processing device (a server) 500 serving as a server transmitting content will be described. The information processing device (the server) 500 is configured to load, for example, a first media 510 serving as a storage medium for copy source content and a second media 550 serving as a content copy destination. Furthermore, it is not necessary to load two media. For example, the copy destination media may be loaded on another device connected via a USB cable, a wireless communication, or the like so that copied data is output.

As the first media 510 and the second media 550, for example, various media (information storage media) such as a Blu-ray Disc (registered trademark), a DVD, a hard disk, and a flash memory may be used.

As shown in FIG. 20, the information processing device (the server) 500 includes a data processing section (a control section) 501, a communication section 502, an input section 503, an output section 504, a memory 505, a first media interface 506, a second media interface 507, and a data conversion section (a transcoder).

The data processing section 501 is configured as a CPU having a function of performing various data processing programs. For example, the data processing section may perform not only the data recording and reproducing process, but also various processes with the content transmission process according to the above-described flowchart. Furthermore, the data processing section controls the general processes performed by the device, such as a communication process with respect to the management server 540 or the client 700 via the communication section 502.

The data conversion section (the transcoder) 521 performs a data conversion process in the copy process.

For example, the data conversion section performs the conversion processes below.

(1) Conversion of encoding format (conversion of format between MPEG-2 and AVC)

(2) Conversion of compressing rate

(3) Removal of stream

The communication section 502 is used for the communication process with respect to the management server 540 or the client device 700 receiving and reproducing the content.

The input section 503 is, for example, a manipulation section for the user, and performs various inputs of a data recording or reproducing instruction, a copy instruction, a content transmission instruction, and the like. Furthermore, the input section 503 also includes a remote controller, so that remote controller manipulation information may be input therethrough. The output section 504 is an image/voice output section configured as a display, a speaker, and the like. The memory 505 is configured as a RAM, a ROM, and the like, and is used as a storage area for a program performed in the data processing section 501, various parameters, received data, or the like. The memory is also used as a buffer region of copied data.

The first media interface 506 is an interface that is applied to a recording process, a reproducing process, and a copy process of data using the first media 510. In accordance with the request of the data processing section 501, a data writing process, a data reading process, a data copy process, a data transmission process, and the like are performed using the first media 510.

The second media interface 507 is an interface that is applied to a recording process, a reproducing process, and a copy process of data using the second media 550. In accordance with the request of the data processing section 501, a data writing process, a data reading process, a data copy process, a data transmission process, and the like are performed using the second media 550.

Next, referring to FIG. 21, the configuration example of the information processing device serving as the client (the client) 700 receiving and reproducing the content transmitted from the server will be described.

As shown in FIG. 21, the information processing device (the client) 700 includes a data processing section (a control section) 701, a communication section 702, an input section 703, an output section 704, and a memory 705.

The data processing section 701 is configured as a CPU having a function of performing various data processing programs. For example, the data processing section may perform not only the data reproducing process, but also various processes with the content receiving and reproducing process according to the above-described flowchart. Furthermore, the data processing section controls the general processes performed by the device, such as a communication process with respect to the server 500 via the communication section 702.

The communication section 702 is used for the communication process with respect to the server 500 transmitting the AV stream or the control information. The input section 703 is, for example, a manipulation section for the user, and performs various inputs of a data reproducing instruction, a data transmission instruction, and the like. Furthermore, the input section 703 also includes a remote controller, so that remote controller manipulation information may be input therethrough. The output section 704 is an image/voice output section configured as a display, a speaker, and the like. The memory 705 is configured as a RAM, a ROM, and the like, and is used as a storage area for a program performed by the data processing section 701, various parameters, or received data.

The disclosure has been described in detail by referring to the specific embodiment. However, it is apparent that corrections or substitutions of the embodiment may be made by a person skilled in the art within the scope of the concept of the disclosure. That is, since the embodiment of the disclosure is merely an example, the disclosure is not limited thereto. In order to determine the concept of the disclosure, it is necessary to refer to the claims.

Furthermore, a series of processes described in the specification may be performed by hardware, software, or a combination thereof. When the process is performed by software, the program storing the process sequence may be installed and performed on the memory inside the computer assembled in the dedicated hardware or the program may be performed by being installed in the general computer performing various processes. For example, the program may be stored on a storage medium in advance. In addition to the method of installing the program from the storage medium to the computer, a method may be adopted in which the program is received via a network such as a LAN (Local Area Network) or an internet and is installed on a storage medium such as a hard disk embedded therein.

Furthermore, various processes described in the specification may be performed in accordance with the time series according to the description or may be performed in parallel or individually if necessary depending on the ability of the process performing the process. Further, the system of the specification indicates a logical assembly structure of a plurality of devices, and it is not limited such that the device of each structure is present in the same casing.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a communication section that performs data communication; and
a data processing section that performs a process of transmitting reproduction data and reproduction control information to a client via the communication section and reproducing the reproduction data based on the reproduction control information in the client,
wherein the data processing section performs a process of converting the reproduction control information into a data format analyzable by the client and transmitting the converted reproduction control information to the client.

2. The information processing device according to claim 1,
wherein the reproduction control information is chapter information, and
wherein the data processing section performs a process of converting chapter reproduction start time information included in the chapter information into real-time information expressed by the units of hours, minutes, and seconds and transmitting the real-time information to the client.

3. The information processing device according to claim 2,
wherein the data processing section performs a process of converting timestamp information representing chapter start time information in the chapter information stored on a playlist file as a reproduction control information file set to correspond to the reproduction data into real-time information expressed by the units of hours, minutes, and seconds and transmitting the real-time information to the client.

4. The information processing device according to claim 1,
wherein the reproduction data and the reproduction control information to be transmitted to the client are copied data obtained by causing the data processing section to copy data stored on a first media to a second media under the management of a management server.

5. An information processing device comprising:
a communication section that performs data communication; and
a data processing section that performs a process of transmitting reproduction data and reproduction control information to a client via the communication section and reproducing the reproduction data based on the reproduction control information in the client,
wherein the data processing section performs a process of receiving stream selection information selected by the client on the basis of the reproduction control information transmitted to the client, selecting a transmission stream in accordance with the received stream selection information, and transmitting the selection stream to the client.

6. The information processing device according to claim 5,
wherein the reproduction control information is voice/subtitle selection information, and
wherein the data processing section performs a process of transmitting voice/subtitle option information to the client, receiving the voice/subtitle selection information selected by the client, selecting at least any one of a voice stream and a subtitles stream to be transmitted in accordance with the received selection information, and transmitting the selection stream to the client.

7. The information processing device according to claim 6,
wherein the data processing section performs a process of transmitting storage information of a stream number table (STN_table) storing information relating to a voice or subtitles stored on a playlist file as a reproduction control information file set to correspond to reproduction data to the client as the option information and receiving the voice/subtitle selection information selected by the client on the basis of the stream number table (STN_table).

8. The information processing device according to claim 5,
wherein the reproduction data and the reproduction control information to be transmitted to the client are copied data obtained by causing the data processing section to copy data stored on a first media to a second media under the management of a management server.

9. An information processing device comprising:
a communication section that performs data communication; and
a data processing section that receives reproduction control information from a server via the communication section, transmits stream selection information selected on the basis of the received reproduction control information to the server, and reproduces data based on a stream transmitted from the server in accordance with the stream selection information.

10. The information processing device according to claim 9,
wherein the reproduction control information is voice/subtitle selection information, and
wherein the data processing section receives voice/subtitle option information from the server, transmits selection information of at least either the voice or the subtitles to the server, and reproduces data based on at least either the voice or the subtitles transmitted from the server in accordance with the selection information.

11. An information processing method performed by an information processing device, comprising:
causing a data processing section to perform data processing by transmitting reproduction data and reproduction control information to a client via a communication section and reproducing data based on the reproduction control information in the client,
wherein in the data processing, the reproduction control information is converted into a data format analyzable by the client and the converted reproduction control information is transmitted to the client.

12. An information processing method performed by an information processing device, comprising:
causing a data processing section to perform data processing by transmitting reproduction data and reproduction control information to a client via a communication section and reproducing data based on the reproduction control information in the client,
wherein in the data processing, stream selection information selected by the client on the basis of the reproduction control information transmitted to the client is received, a transmission stream is selected in accordance with the received stream selection information, and the selection stream is transmitted to the client.

13. An information processing method performed by an information processing device, comprising:
causing a data processing section to receive reproduction control information from a server via a communication section, transmitting stream selection information selected on the basis of the received reproduction control information to the server, and reproducing data based on the stream transmitted from the server in accordance with the stream selection information.

14. A program causing an information processing device to perform an information process, the program causing a data processing section to perform data processing by transmitting reproduction data and reproduction control information to a client via a communication section and reproducing data based on the reproduction control information in the client,
wherein in the data processing, the reproduction control information is converted into a data format analyzable by the client, and the converted reproduction control information is transmitted to the client.

15. A program causing an information processing device to perform an information process, the program causing a data processing section to perform data processing by transmitting reproduction data and reproduction control information to a client via a communication section and reproducing data based on the reproduction control information in the client,
wherein in the data processing, stream selection information selected by the client on the basis of the reproduction control information transmitted to the client is received, a transmission stream is selected in accordance with the received stream selection information, and the selection stream is transmitted to the client.

16. A program causing an information processing device to perform an information process, the program causing a data processing section to receive reproduction control information from a server via a communication section, transmit stream selection information selected on the basis of the received reproduction control information to the server, and reproduce data based on a stream transmitted from the server in accordance with the stream selection information.
